(19) United States
(12) Patent Application Publication
(10) Pub. No.: US 2023/0397558 A1
(43) Pub. Date: Dec. 14, 2023

(54) Cultivation Hub and Market

(71) Applicant: BRICK STREET FARMS LLC, St. Petersburg, FL (US)

(72) Inventors: O'Malley Shannon, St. Petersburg, FL (US); Doyle Bradley, St. Petersburg, FL (US)

(21) Appl. No.: 18/037,587

(22) PCT Filed: Nov. 1, 2022
(86) PCT No.: PCT/US2022/079054

§ 371 Date: May 18, 2023

Related U.S. Application Data
(60) Provisional application No. 63/274,199, filed on Nov. 1, 2021.

(51) Int. Cl. A01G 31/06; A01G 9/24; A01G 9/18; G06Q 50/02

(52) U.S. Cl. CPC A01G 31/06; A01G 9/246; A01G 9/18; G06Q 50/02

(57) ABSTRACT

The invention relates to an easy to use system that provides a shipping container farm which utilizes multiple NFT grow pods, a propagation pod and a filtration and fertigation (PFF) pod that enables a user to grow 4,400-12,000 plants per month per NFT pod and provides the infrastructure to raise the plants from seed to harvest. The system also provides an integrated system which provides nutrients, water, light and controlled atmosphere to raise the crops as well as an integrated cold storage pod and retail store pod.

### BACKGROUND OF THE INVENTION

### 1) Field of the Invention

The invention relates to the field of agriculture technology which utilizes multiple modular containerized hydroponic growing systems to grow leafy greens and culinary herbs. The invention utilizes the Internet of Things (IoT) technology to remotely control and monitor the system components which facilitates the user to analyze sensor data for business intelligence purposes.

### 2) Description of Related Art

A number of systems already exist that provide a container-based system that is capable of growing produce either hydroponically, aeroponically or using conventionally soil matrixes. These container-based systems are limited in type or selection as well as by the size of the container interior which is generally relatively small in scale. The current container farm implementations do not provide for a compete cycle of product such as growing crops from seed to harvest and integrating it with a distribution system.

In particular there is a need for a system that is expandable and allows a user to have multiple growing pods that provide a complete ecosystem dedicated to farming on a macro level. Additionally, the system should provide growing areas for both nursery stage crops and mature harvesting stage crops.

### BRIEF SUMMARY OF THE INVENTION

The instant invention in one form is directed to an easy-to-use system that provides a multiple grow pod farm solution for raising crops formed from shipping containers. The grow pod farm can have either multiple an all-in-one shipping container that enables a user to grow 4,400-12,000 plants per month in each grow pod formed from a shipping container, or the instant invention can have multiple grow pods for mature plants and at least one or more nursery pods. The system can also have a service pod that provides services for the nursery and grow pods, or the grow pods can have their own service modules built into each grow pods. The services module provides the infrastructure to raise the plants from seed to harvest. The instant invention service pod provides an integrated system which provides nutrients, water, light, control and atmosphere control necessary to raise the crops. The system utilizes High Cube Refrigerated Shipping Containers (HCRSC) as the grow pods, service pod, nursery pod, cold storage pod, growing support, dry storage, and retail store pod which provides an insulated container platform. The insulated container platform provides the environment need to maintain the environmental conditions to support optimum plant growth and other user functions.

Alternatively, the grow pod can be configured into a stand alone device with the grow and nursery features integrated into a single unit.

The instant invention provides two distinct grow zones for the plants. The first grow zone provides a separate seed nursery, which allows the user to start the plants from seeds. Ideally this is a separate nursery pod configured to optimize the growth of plants during the nursery stage. However, the instant invention envisions the ability to have both the nursery and mature plants in one grow pod. The second grow zone provides the growing platform that allows the user to transplant baby plants from the nursery into hollow growing channels where the plants are nourished until maturity. Ideally these are separate grow pods configured to optimize the growth of plants during the adult stage. The instant invention envisions that the grow pods for mature plants can also be dedicated to one plant type so that the conditions in the grow pod can be optimized for the specific plant type. The instant invention also provides the functionality to facilitate harvesting of plants when they are ready and preparation of the growing zones within the grow pods for the next harvest.

The system is controlled by an integrated controller that monitors all the environmental and safety systems for each of the grow pods. The controller has a controller program that connects to and oversees at least the following systems integrated into the HCRSC containers, which form the grow pods: water system, environmental and climate control system, and human safety controls. The controller can be monitored from an onsite control panel or remotely from a cloud application using the control application of the instant invention. The ability of the controller to supply information globally to the cloud and receive instructions from a remote control and monitoring station or mobile device provides the users the flexibility to monitor the instant invention and to control the systems and environment to ensure that the crops have optimum growing conditions and to be alert to problems within the grow pods or nursery pods.

An advantage of the present invention is that it provides the user with a configurable platform that provides a self-contained farm based on multiple grow pods that are capable raising crops in an indoor or outdoor environment and the grow pods have a dedicated service module which controls all the processes needed to feed and raise crops with a simple control system which has an easy-to-use interface and cloud accessibility.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a top cutaway view of a standalone pod of the instant invention showing the zones and racks that support the grow channels, water distribution and HVAC system;

FIG. 2 is a distal end view of the racks looking inward from the distal wall of the HCRSC container a standalone pod;

FIG. 3 is a proximal end view of the equipment mounted on the interior of the proximal wall of a standalone pod;

FIG. 4 is a distal end view of the container looking at the exterior distal wall of the NFT pod from inside a standalone pod;

FIG. 5 is a proximal end view of exterior of the proximal wall of a standalone pod;

FIG. 6 is a cutaway elevation view of a standalone pod looking to the left side of the instant invention showing the grow zones and propagation (nursery) zone;

FIG. 7 is a cutaway elevation view a standalone pod looking to the right side of the instant invention showing the grow zones;

FIG. 8 is a cutaway elevation view looking to the left side of a standalone pod instant invention; showing lighting and fan locations;

FIG. 9 is a cutaway elevation view looking to the right side of a standalone pod instant invention showing lighting and fan locations;

FIG. 10A shows a plan view layout of the NFT pod layout of the instant invention.

FIG. 10B shows the exterior wall view of the NFT pod layout of the instant invention showing the HVAC system.

FIG. 10C is an interior view that shows the zone fans and grow racks of the NFT pod of the instant invention.

FIG. 10D shows the control panel and water tank of the NFT pod of the instant invention

FIG. 10E shows the dosing loop plumbing schematic of the NFT container of the instant invention.

FIG. 10F shows a plan view layout of the PFF pod layout of the instant invention.

FIG. 10G shows an elevation side view layout of the PFF pod layout of the instant invention showing the zone and bay lighting layout.

FIG. 10H shows representative elevation end view layouts of the PFF pod layout of the instant invention.

FIG. 11 shows the system controller of the instant invention;

FIG. 12 shows an isometric view of the water tank used in the NFT containers;

FIG. 13 shows a typical feeder arm used in the NFT container;

FIG. 14 shows a typical HVAC and lighting schematic of the instant invention;

FIG. 15 shows a typical Input and Output (I/O) schematic of the instant invention;

FIG. 16A(1) shows a block diagram of the PFF and NFT Room Human Safety Control

FIG. 16A(2) shows a block diagram of the NFT Room Water Management system;

FIG. 16A(3) shows a block diagram of the NFT Room/Climate Control;

FIG. 16A(4) shows a block diagram of the PPF and Cold Storage Room Environment/Climate Control;

FIG. 16A(5) shows a block diagram of the PFF Room Water Management Controls;

FIG. 16A(6) shows a block diagram of the Growth Controlled—Fertigation;

FIG. 16A(7) shows a block diagram of the Load network Cabinet Inside PFF Room;

FIG. 16A(8) shows a block diagram of the site Infrastructure and features;

FIG. 16A(9) shows a block diagram of the GL NFT Control Panel;

FIG. 16A(10) shows a block diagram of the Growlink Cloud on Azure;

FIG. 16B(1) shows a block diagram of the NFT water management system;

FIG. 16B(2) shows a block diagram of the Main feed Loop and Recirculating Line Loop;

FIG. 17(1) shows a block diagram of the upper portion of the PFF water management control system;

FIG. 17(2) shows a block diagram of the top middle portion of the PFF water management control system;

FIG. 17(3) shows a block diagram of the bottom middle portion of the PFF water management control system;

FIG. 17(4) shows a block diagram of the lower portion of the PFF water management control system;

FIG. 18 shows a perspective view of a an 8 NFT pod and a single pod nursery system;

FIG. 19 shows the storage and tanks supply for nutrients for the system; and

FIG. 20 shows the mixing and fresh water storage schematic.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The term platform and system are used interchangeably within the specification and are intended to mean a multi-pod growing platform containing all the processes needed to feed and raise crops in multiple grow pods.

The term container, standalone pod, NFT pod, pod and HCRSC container are used interchangeably within the specification and are intended to mean a pod formed from an HCRSC container which is used to form a multi-pod growing platform containing all the processes needed to feed and raise crops in multiple grow pods.

The terms plant, plants, crop and crops as used in within the specification means any type of plant that can be cultivated in an indoor environment.

The term control system and controller as used in the specification is intended to mean an electrical/electronic system used to control or receive information from a variety of electrical devices such as switches, sensors, motor controllers, lighting controllers, fan controllers and other electrical and electronic devices and is capable of providing information to a cloud-based server with a cloud-based control application of the instant invention.

The term cloud management system as used in this specification means a remote system that receives information from the control system and allows at least one user the ability to view information and input operating parameters to modify, start, stop, remotely control and monitor system components contained within the instant invention.

The term control valve as used in this specification is meant to mean a device for turning off or modifying the flow rate of a fluid within a piping system.

The term fertigation as used in the specification means the application of fertilizer with irrigation or nutrient water.

The term Nutrient Film Technique (NFT) is a hydroponic technique wherein a very shallow stream of water containing all the dissolved nutrients required for plant growth is re-circulated past the bare roots of plants in a watertight gully, also known as channels. The specification utilizes channels and Nutrient Film Technique interchangeably.

Prior to a discussion of the preferred embodiment of the invention, it should be understood that the invention is a modular containerized hydroponic growing system for plants including leafy greens and culinary herbs that uses Internet of Things (IoT) technology to remotely control and monitor system components and analyze sensor data for business intelligence purposes specific to the growing of plants.

The instant invention can utilize either multiple stand alone pods, multiple integrated pods where there is NFT and PFF pods or a combination of each to meet a user's requirements.

The instant invention can utilize either a single or multiple control systems to support processes within the farm. The single or multiple control systems control all the functions within the farm including but not limited to the hydroponic processes, such as a water management control system, an environment/climate control system, human and safety systems and lighting in the NFT pods, filtration and fertigation (PFF) pod, the cold storage pod, the retail store pod and nursery pod. When more than one control system is used, they communicate together to form a network which is then connected to the cloud server. When a single control system that system is connected to the cloud server.

The instant invention also integrates the technology into a flexible system that has multiple grow pods, each of which has multiple grow zones for maturing plants and a separate nursery grow pod for starting plants from seed. This two-zone system permits seed cultivation (nursery stage crops) to occur within the same farm as the mature production (harvesting stage crops). Once the mature production is harvested the NFT channels in the grow pods can be cleaned and the plants from the nursery can be transplanted to the cleaned NFT channels and raised to maturity. The instant invention also envisions integration of all the systems into a single standalone pod and the farm can have a mixture of NFT, PFF and standalone pods to make up the growing pod infrastructure.

The instant invention provides the user with a multi-container grow pod solution that provides increased component and resource efficiencies versus a standalone, all-in-one containerized farming system. The system is able to provide urban communities with large volume food production directly at the point of consumption, and it significantly reduces water usage and eliminates traditional agriculture runoff pollution by efficiently and sustainably producing food for direct sale to surrounding communities and food establishments. The instant invention also uses advanced water reclamation and treatment techniques with integrated microgrid solutions that include on-site solar, natural gas generator, and backup power storage technologies such as battery backup.

An important aspect of the multi grow pod configuration is that the crops can be staged to provide crops continuously. As crops reach maturity in one or more grow pods, crops in other grow pods reach earlier growth stages. Consequently, there is a continuous flow of mature produce for harvesting. The instant invention provides the added benefit of large volume food production directly at the point of consumption, such as embedded into an urban neighborhood.

The instant invention can be viewed as a technological solution to provide large scale food production that can benefit any community that values fresh, locally-grown produce. It accomplishes the growing of high-quality food by utilizing a number of integrated systems built into the container grow pod configuration.

The instant invention grow pod configuration is flexible and can be installed inside a structure, installed in a outdoors configuration or be installed under a single roof system to shield the container grow pods and nursery pod from the elements. Alternatively, the instant invention can take advantage of the large roof surface for the installation of solar panels. The panels can alternatively be a mixture of electrical solar or solar hot water. When using solar hot water panels, the resulting solar panels can be used to heat the water used to supply the nutrients, used to heat the air in the container grow pods, or support any other function requiring hot water. The water can alternatively be heated using electric heaters or fossil fuel heaters.

The ability for the instant invention to control water, nutrients, CO₂ levels, temperature and lighting systems means that for each of the container grow pods the environment can be optimized. This means that the plants have the ideal growing conditions and therefore they mature quicker which reduces the time for a plant to reach maturity and therefore decreases the time between harvest of the plants. Simply put this provides the user the ability to harvest more product during any calendar year due to the reduced time needed to raise the plants to maturity.

Furthermore, as envisioned the instant invention has many potential users including but not limited to traditional agriculture, food distribution entities, educational institutions, government and corporate entities. These entities would have an interest in operating sustainable vertical growing operations in densely populated urban corridors that service the immediate surrounding community.

Expanding the potential uses another customer for the instant invention includes educational institutions. The educational institutions' uses can include the ability to provide on-site production of fresh vegetables and/or an R&D facility for programs related to science, technology, and/or agriculture.

As noted, the instant invention is a modular multi-unit grow pod farm based on containerized hydroponic growing system for plants including leafy greens and culinary herbs that uses Internet of Things (IoT) technology to remotely control and monitor system components and analyze sensor data.

The instant invention is constructed from multiple High Cube Refrigerated Shipping Containers (HCRSC). These containers are specialized and include the NFT grow pod, the propagation, filtration and fertigation (PFF) pod, the cold storage pod, the retail store pod.

The resulting HCRSC container becomes a NFT grow pod which is connected to a number of shared and dedicated resources including but not limited to the condensate reclamation, advanced water reclamation and treatment system, integrated microgrid solutions that include on-site solar with battery storage backup, natural gas generator, propagation, filtration and fertigation (PFF) pod, refrigerated shipping container for cold storage pod, growing support, dry storage, and retail store pod, rainwater collection, depleted nutrient water reclamation, farm water usage and energy meters monitoring, refrigerated pickup lockers, controllable water share filling station, climate control system, central and distributed controllers, CO₂ injection system, lighting system, airflow system, water dosing, cleansing, irrigation control systems and human life safety system.

The flexibility of the instant invention and the individual pods requires that the pods be customized to support the required functions.

The HCRSC container is modified for use as an NFT grow pod suitable for supporting a high yield grow environment (the instant invention envisions utilizing both new and used HCRSC container). While the process defines specific items and sequences the items and sequences can be modified or changed depending on the needs of the NFT grow pod and installation. This procedure is repeated for every NFT grow pod:
a. Install 180-gallon stainless steel tank.
b. Prep NFT channels by attaching end caps and drain caps, drill end caps for feed tubes from removable supply/feed manifold.
c. Mount climate control HVAV unit for cooling, heating, dehumidification, and commercial room ventilation and fresh-air exchange.
d. Install central CO₂ for entire site and run supply lines to each NFT grow pod. Install CO₂ injection regulator valve on the inside distal wall with an exterior shut off valve. Connect the CO₂ regulator solenoid to the CO₂ infusion tube and run the tube the entire length of the NFT grow pod on the ceiling over the center walking/working aisle of the NFT grow pod. When the CO₂ injection regulator valve is activated, it allows CO₂ to be infused the environment from the ceiling. Each NFT grow pod has a network ceiling fans, floor fans and row fans distribute the CO₂ around the NFT grow pod.
e. Mount local control panel on inside on the back wall between the climate control HVAC unit air supply and air return.
f. Install the main distribution panel and all electrical conduits, junction boxes, outlets, and wires.
g. Install DIN rail at end of NFT zones, spaced appropriately to mount water-resistant quadruple row fans on each row and wire into each zone's row fan line voltage junction box.
h. Mount ceiling fans so that they are blowing towards the entry door and plug into ceiling outlets.
i. Mount climate sensor in proximal corner of the pod and wire into power/communications junction box.
j. Install main irrigation supply/feed line, water flow switch, spin down filter, and removable row level flow rate control supply/feed manifolds.
k. Install row gutters and tie into PVC down spout to the downspout manifold at the end of each row in each zone.
l. Place NFT channels into each row of each zone, install supply/feed manifold tubing into each channel end cap.
m. Install recirculating line off the main irrigation supply/feed trunk and install at least one port for a water flow switch.
n. Create two distal wall penetrations and install plumbing to route the recirculating line water outside to the sand filter, UV water treatment device, water chiller, and back thru the wall into the recirculating water reservoir.
o. Install incoming auto fill line and actuated ball valve from the Centralized Propagation, Filtration, and Fertigation (PFF) Pod
p. Install incoming auto fill line and actuated ball valve from a centralized carbon filtered water filtration line which is used for pH UP control and reservoir tank rinsing.
q. Install the pump with variable frequency drive (VFD) and connect to the dedicated electrical junction box for the VFD drive. Connect the main irrigation line and bulkhead suction to recirculating water reservoir to the pump.
r. Connect the zone water return line into recirculating water reservoir so that it enters the tank from the top of the tank.
s. Install Horticulture LED fixtures on each zone and daisy chain light fixtures in each column or NFT channel zone to each other. Connect the bottom light of each column or NFT channel zone into that power supply in each NFT channel zone. Each NFT channel zone lights are daisy chained together such that the first one terminates into each zone's line voltage junction box as well as that zone's 0-10 v dimming junction box.
t. Install an air curtain above entry door, install smoke/fire alarms, install fire extinguisher, and install lighted emergency exit sign and tie smoke/fire alarm into dedicated low voltage junction box for integration into the control panel
u. Create distal wall penetration dedicated to smoke alarm relay wiring to enable connection to a site level fire emergency system
v. Plumb all NFT grow pod gravity drain flush lines to the underground settling tank
w. Plumb all NFT grow pod HVAC condensate drain lines to condensate reclamation system comprised of a tank with sump pump and high float switch sensor.
x. Install solar panels and necessary equipment to the roof of the NFT grow pod and wire into solar sub-panel and the main distribution panel.

The next step is to modified a container for use as a propagation, filtration and fertigation (PFF) pod suitable for supporting a high yield grow environment (the instant invention envisions utilizing both new and used container). While the process defines specific items and sequences the items and sequences can be modified or changed depending on the needs of the PFF pod and installation. This procedure is repeated for every PFF pod:
a. Mount climate control HVAV unit for cooling, heating, dehumidification, and commercial room ventilation and fresh-air exchange.
b. Mount the control panel and central fertigation skid on inside wall. This controls all propagation, filtration, and fertigation equipment in PFF Pod.
c. Install the required number of automated ball valve manifolds downstream from the central fertigation skid, and run to each NFT pods' recirculating nutrient water reservoir, with an extra line connected directly to the in-pod propagation recirculating nutrient reservoir.
d. Install an air compressor and air dryer. These are needed to provide proper operation of the injector dosing pumps.
e. Install all electrical conduits, wire troughs, junction boxes, outlets, and wires to connect all the associate process equipment.
f. Install three source water holding tanks (preferably at least 1000-gallon capacity each) next to a depleted nutrient water settling tank (preferably at least 200-gallon capacity), and one condensate reclamation tank with sump pump (preferably at least 75-gallon capacity). The water settling tank is installed underground and overflows at the top into the condensate reclamation tank. The condensate reclamation tank has a sump with a high lever sensor switch installed.
g. Install a condensate reclamation tank pump sediment filter after the condensate reclamation tank pump. When the condensate reclamation tank high lever sensor switch is made then the pump transfers the mixture of old nutrient water and reclaimed condensate water thru the sediment filter. Also, install two pressure differential switches one upstream and one downstream of the sediment filter so that the control system can alert when the sediment filter needs to be changed.
h. Install a chlorine injection system before the sediment filter such that the filtered and chlorine treated water enters one of three source water holding tanks. Install the rainwater collection system such that rainwater is collected from the PFF pod roof and routed to one of three source water holding tanks.
i. Install two peristaltic fixed volume dosing pumps in the water line connecting the underground reclamation tank to the source water holding tank. Install the peristaltic fixed volume dosing pumps such that the water is then routed through the sediment filter. The two peristaltic fixed volume dosing pumps are used to inject a concentrated chlorine solution into the water line as water is pumped from the underground reclamation tanks and through sediment filter.
j. Install a flow switch/meter in the water line to measure the flow of the reclaimed, filtered, and chlorine-treated water prior to entering the into the source water holding tanks. The chlorine dosing pumps are activated by the flow switch/meter to infuse chlorine into the water. A low float switch is installed on the chlorine solution holding tank to alert when the tank needs to be refilled.
k. The municipal water supply line is installed on the rainwater collection holding tank with a low side and high side inside mechanical float valves and activated when reclaimed water in the water holding tanks is low. A low side municipal fill line is connected to the rainwater collection holding tank and is used during wet seasons and a high side municipal fill line is connected to the rainwater collection holding tank and it is used during dry seasons.
l. Connect all three source-water holding tanks together with the third tank high side overflow into the stormwater collection system. The stormwater collection system is preferably installed in a pit constructed underneath the PFF pod.
m. Install the finished source water holding tank and connect all source water holding tanks together.
n. Install the Reverse Osmosis (RO) filtration system with carbon and softener pre-filters which outputs to a calcite cartridge filter and housing. The calcite cartridge filter re-mineralizes the RO water and adds pH buffering alkalinity back into the water before it is delivered to a finished source water holding tank inside the PFF Pod.
o. Install a demand pressure pump between two of the source-water holding tanks and plumb the water output into the RO filtration system input line.
p. Install the recirculating line, pump, pH sensor, electrical conductivity (EC) sensor, tank level sensor, flow switch, UV water treatment device, and nano bubble generator and attached to the finished source water holding tank. Install 2 controllable valves on the finished source water holding tank. The Nano bubble generator is installed such that when water flow in the recirculating line stops or the oxygen stops flowing from the attached O₂ tank/O₂ generator, the two valves are activated and enable the nano bubble generator to gravity drain the water inside the generator to the rainwater collection holding tank. This is done to protect the nano bubble generator from having static water for long periods of time inside the nano bubble generator, which can damage the nano bubble generator. When the recirculating pump stops, the flow switch on the water line activates the nano bubble generator valves and shuts the power off to the light in the UV water treatment device. Once all the water sensors and valves have been installed install the control wiring to the proper control panel termination blocks.
q. Connect the demand pressure fertigation pump input to finished source water holding tank and output to the central fertigation skid input line.
r. Install the propagation reservoir recirculating line and pump, water flow switch, pH sensor, EC sensor, water temperature sensor, sand filter, UV water treatment device, and connect the line to the reservoir.
s. Install the propagation reservoir tank level sensor and wire into appropriate junction box.
t. Connect condensate drain line to underground condensate reclamation tank with sump pump and high float switch sensor.
u. Connect propagation reservoir gravity drain flush line to the underground settling tank.
v. Mount ceiling fans so that they are blowing towards the entry door and plug into appropriate ceiling outlets.
w. Mount climate sensor in proximal corner of the pod and wire into appropriate power/communications junction box.
x. Install propagation racks and connect to supply/feed main line for each rack such that the system can feed a single rack at a time and allow the rack to drain back to the recirculating reservoir before triggering the next rack's feeding session. Install control vales in each rack one to supply/feed the rack and one drain valve that controls the flooding and drain of the rack and tables. The low side bulkhead valve is for supply/feed and doubles as the main drain once feeding session is complete. The high side bulkhead valve is used for overflow and is connected directly to a reservoir return line so the feeding water can run continuously without overflowing the flood tables.
y. Install the demand pressure propagation pump and connect it to the recirculating reservoir using the water supply/feed lines to each of the racks.
z. Assemble the propagation flood and drain racks with six levels, and install flood and drain tables on each level with low and high overflow bulkheads.
aa. Install horticulture LEDs on each propagation rack and on each level. Connect the LEDs to the power supply on top of the rack and wire the LEDs to control panel.
bb. Install a network cabinet and equipment, including firewall, along with a small Programmable Logic Controller (PLC). The PLC is used to program the control of emergency loss of power protocols using the natural gas-powered generator to provide backup power to the instant invention. The on-site generator is capable of providing power to PFF pod, cold storage pod, NFT pod power Loss Switches (Local and Site). The on-site generator also provides power to the control system that provides power to critical systems in the NFT pods. When running on on-site generator power the control system will power only two NFT pods at a time, and after a preprogramed period will shut those pods and power up two other NFT pods and repeat the cycle until all pods have been service before returning power to the first NFT pods. This cycle is designed to keep plants alive in NFT pods until grid power is restored.
cc. Install solar panels and necessary equipment to the roof of the PFF pod and wire into solar sub-panel and the main distribution panel.

The next step is to modify a HCRSC container for use as a cold storage pod, the instant invention envisions utilizing both new and used HCRSC container. While the process defines specific items and sequences the items and sequences can be modified or changed depending on the needs of the cold storage pod and installation. This procedure is repeated for every cold storage pod:
a. Install entry door that matches the NFT pod and PFF pod.
b. Install basic house lights and wall thermostat controls.
c. Install climate sensors and integrated and wired into the PFF Pod control panel for temperature and humidity monitoring. The PFF Pod control panel provides the associated alarms and alerts applicable to the cold storage pod.
d. Install solar panels and necessary equipment to the roof of the cold storage pod and wire into solar sub-panel and the main distribution panel.

The next step is to modify at least one and preferably four HCRSC containers for use as a growing support, dry storage and retail store pod, the instant invention envisions utilizing both new and used HCRSC container. While the process defines specific items and sequences the items and sequences can be modified or changed depending on the needs of the growing support, dry storage and retail store pod and installation This procedure is repeated for every growing support, dry storage and retail store pod.
i. Using four HCRSC container configure them to support the growing support, dry storage and retail store pod and create a single space. Two HCRSC containers will make up the retail space for the on-site specialty gourmet market with integrated refrigerated pickup lockers, one HCRSC container will be for dry storage and includes an ADA accessible restroom, and one HCRSC container is for packaging, seeding, and other plant growing support activities.
   a. Retail Store Containers have integrated electrical supply for exterior refrigerated lockers to be installed for custom self-service pickup.
   b. Install solar panels across the 4-container block of containers and necessary equipment to the roof of the growing support, dry storage and retail store pod and wire into solar sub-panel and the main distribution panel.
   c. install a rain collection system mounted underneath the panels that runs collected rainwater to a source water holding tank.

The instant invention, while being comprised of various discrete systems and structures, is not just a single piece of piece of equipment but it is a collection of integrated pieces of equipment and these integrated pieces of equipment form various features of the overall system.

The instant invention incorporates the following integrated features which address the growing and distribution systems of the instant invention:
i. A custom designed water reclamation solutions that has a micro water treatment and filtration subsystem.
ii. An integrated on-site microgrid energy generating solutions which supports solar power to supplement the power requirements of the facility and a Natural Gas Generator. The solar system is located on the NFT Pods/Cold Storage pods, PFF pod, Covered Walkway, and 4 Growing Support & Retail Store pods.
iii. A natural gas fired generator and transfer switch is integrated and designed to control critical energy reliant equipment in the case of a grid power outage.
iv. A rainwater collection which is installed under the solar panels of the NFT Pods/Cold Storage pods, PFF pod, Covered Walkway, and 4 Growing Support & Retail Store pods.
v. A condensate reclamation system that collects the condensate from the HVAC systems. The condensate reclamation system provides the facility with water and minimizes the reliance on outside water resources. Each NFT pod uses, on average, 20 gallons of water per day, and the condensate reclamation can supply a significant amount of the water needed to operate the recirculating reservoirs. Rainwater collection and municipal water supplies are therefore backup water sources for the instant invention. The backup sources of water are primarily used when recirculating reservoirs perform multiple depleted nutrient water flushes within the same time period and to refill the central fertigation system.
Condensate collection from all the HVAC systems gravity drain into a central line carrying it to a holding tank with a high-side, float-switch-activated sump pump.
vi. A depleted nutrient water reclamation system, the instant invention utilizes multiple recirculating nutrient water reservoirs located in the NFT pods, and the propagation nursery (PFF pod). Periodically a gravity flush of each recirculating reservoirs depleted nutrient water is performed which is initiated by the control system and the water is transferred to the underground holding tank where debris and particulates settle to the bottom and a high side overflow drains the water to the underground condensate reclamation holding tank where the sump pump high side float switch initiates pumping the water through filters and thru a chlorine injection system to treat the water for any biological contaminants such as bacteria, spores, or any other unwanted microbials. The allows the instant invention to minimize wasting water.
vii. Farm Water Usage and Energy Meters. The instant invention has energy meters installed on each pod's main distribution panel and wired to the control system for energy monitoring purposes. A water meter is also installed on the PFF pod's incoming source water holding tanks line and wired to the control system for tracking and monitoring water usage for all “grow pods.”
viii. Refrigerated pickup lockers are installed outside the retail store front for customer order pickups. These lockers are integrated with the e-commerce software platform so customers can order online and pickup their order by scanning a barcode/QR code delivered to them in their order email confirmation.
ix. Controllable Water Share Filling Station for Membership Program. The instant invention envisions a membership program for repeat customers of the e-commerce platform. Customers who are part of the Membership Program have access to an unlimited water share program. The control system enables the scheduling of water when available so that members can fill their water containers at the water fill stations which are installed in the retail store front. Members use a scannable membership ID, such as an NFC tag or barcode/QR code that enables water fill sessions to occur.

The instant invention provides a fully integrated climate control system for the NFT pods and PFF pod that consists of the following integrates subsystems.
i. Cooling/Dehumidification/Ventilation.
   a. The HVAC units with integrated dehumidification and commercial room ventilation circuit are used to maintain temperature and relative humidity for day mode and night mode as well as schedule fresh air exchanges using ventilation with inline HEPA rated filters to minimize outside spores entering the NFT pods and PFF pod. Sensor data and schedule information are used by the control system program to manage cooling, dehumidification and ventilation based on a schedule entered into the control system or climate sensor readings.
ii. CO₂ for the NFT pods and PFF pod. CO₂ is injected, based on climate sensor readings and settings programed into the control system to distribute CO₂ during day mode until the desired parts per million (ppm) CO₂ is reached. Typically, the preferred amount of CO₂ in the container depends on the plants being grown, but the recommended normal target for the CO₂ level is two to three times the average CO₂ level of ambient atmosphere (approximately 400 ppm).
The instant invention uses a central CO₂ tank that is controlled by sensors connected to the control system that utilizes programmable settings to maintain CO₂ levels. The CO₂ system controls the CO₂ content of the container to optimize the plant growth. The system controller is connected to the CO₂ system, and the system controller monitors and controls the CO₂ content of the air in the container by adding CO₂ to the air in the container. system controller utilizes both information from the CO₂ sensors and schedule information to adjust the CO₂ levels in the container to ensure that the levels are optimum to promote plant growth. The instant invention also envisions that the CO₂ supply can be either CO₂ cylinders or a separate mycelium type CO₂ production system.
iii. The control of the CO₂ content of the air in the container is accomplished by operating the CO₂ valve attached to the tubing previously installed and dosing the container with CO₂ until the desired amount of CO₂ is sensed by the CO₂ sensor and the system controller turns off the system.
iv. Horticulture LEDs in the NFT pods and PFF pod. The instant invention utilizes LED lighting to provide the light for the plants and the LED lights used have a specific spectrum designed for leafy green, vegetative stage production. The lights are controlled using a schedule programed into the control system and are based on a grower's Daily Light Integral (DLI) target, lighting algorithms are configured to turn lights on after sundown, when electricity is cheapest, and run for between 12-18 hours depending on crop under cultivation.
v. Air flow systems integrated into the NFT pods and PFF pod are design to create a three-dimensional air flow system. The air flow system comprises fans to transport the HVAC system treated air to the proximal end of the pod, floor fans carry return air back to the HVAC system at the distal end of the pod and the row fans provide humidity reducing air flow across the top of the canopy.
   i. Ceiling fans carry treated air from the HVAC system air supply at the distal end of the pod to the proximal end of the pod where the climate sensor is mounted. These fans hang from the ceiling.
   ii. Floor fans carry air back to HVAC system air return at the distal end of the pod.
   iii. The row fans are mounted on each row and provide humidity reducing air flow across the top of the canopy.
vi. Climate Sensors (NFT pods, PFF pod and Cold Storage Pods).
   a. The instant invention uses an integrated climate control sensor. This sensor controls when cooling, dehumidification, and CO₂ generators turn ON and OFF based the control system program or the climate sensor readings.

The Water Dosing, Cleansing & Irrigation Control Systems for the NFT pods and PFF pod is designed to provide the crops with water and nutrients. The system comprises:
i. Recirculating Nutrient Reservoir Fill & Flush.
   a. The control system uses a pressure transducer to determine when to open and close the reservoir fill valve. The pressure transducer is scaled in the control system based on reservoir dimensions to calculate water level based the pressure transducer's pressure reading from the water in the reservoir. However, the instant invention also envisions utilizing level switches, ultrasonic sensors and capacitive sensors to determine the water level of the reservoir. When using a pressure transducer, the sensor program as defined in control system determines when to fill the reservoir based on a defined water level percentage and stop filling once it has reached the defined high level setpoint percentage.
ii. Water sent to recirculating water reservoirs.
   a. All water sent to recirculating water reservoirs, from the PFF pod Central Fertigation system has been treated to adjust the pH and nutrient level adjusted as the re-mineralized Reverse Osmosis filtered water flows through that system, The injector pumps inject directly into the recirculating line based on mL/gallon configurations in the control system software.
iii. The water reservoir gravity-based water flush.
   a. The water reservoir has a gravity-based water flush which is controlled by the control system program and it is followed by an autofill to enable automated nutrient water change outs. The control system program automatically disables fill capabilities when flush is activated and when flush is complete, the fill valve opens and refills the reservoir with pH and nutrient injected filtered/re-mineralized water from the PFF Pod's Central Fertigation system. The pump then restarts and the water flows to NFT channels.
iv. The instant invention utilizes water sensors that include water level, flow switch, pH, Electrical conductivity (EC) and temperature sensors.
   a. A pressure transducer installed at the bottom on the exterior of the recirculating water reservoir regulates the water level and controls the Fill and Flush controls based on the program and configurations in the control system software. Pressure values are equated to percentage full values in the control system software to enable users to tune and calibrate the pressure transducer as needed.
   b. The main pump water flow switch is installed directly after the main irrigation supply/feed line to enable the control system to send alerts when there is insufficient water flow. This allows remote monitoring of the water flow and provides the operators with the ability to respond quickly if the water flow rate drops below set limits in the control system.
   c. The recirculating line water flow switch is installed in the main irrigation line. The purpose of the recirculating line water flow switch is to enable monitoring of water flow to ensure proper operation of the pump, pH, EC, and water temperature sensors, sand filter, UV water treatment device, water chiller and water reservoir. When the water flow is stopped, the control system generates an alert and automatically turns off the injector pumps and UV water treatment device so that improper pH/EC sensor readings do not trigger filling of the water reservoir from the Central Fertigation. This also has the added benefit of providing the control system the information needed to turn off the UV light to protect it from operating without proper water flow rates.
v. The instant invention utilizes process variables comprised of pH and EC probes and other relevant sensors, which are installed on the recirculating line. The control system has programed set points for each process variable monitored within the Central Fertigation system and the Central Fertigation system is activated and deactivated to keep the values within defined ranges programed for each sensor.
vi. Water temperature sensor are installed in the recirculating line and are used to monitor water temperature and alert users to readings outside configured high and low setpoints. Water temperature is used to identify when the water chiller is not operating properly. It is critical to keep the water at 70 degrees or below to reduce potential root pathogen infection pressure which increases as water temperature increases. The water in the recirculating line can be either heated or cooled to achieve the proper operating temperature range. The instant invention envisions cooling the water in the recirculating line during summers and heating water in the recirculating line for systems installed in colder climates.

Water Cleansing Control for the NFT pods and PFF pod.
a. Water cleanliness as it is defined in hydroponics is directly related to levels (ppm) of dissolved oxygen that is measurable in the water. The instant invention has integrated nano bubble technology. Nano bubbles, not to be confused with micro bubbles, are so small and dense, they sink in water. By being small and dense the nano bubbles allow water to become super-saturated with O₂ molecules, which provides many positive attributes with respect to water quality, including reduction of biofilm and scale buildup and destruction of water-borne pathogens such a pythium and fusarium, which are common causes of root rot diseases in plants.
b. The instant invention utilizes four different methods to clean the water:
   PFF Pod Central Fertigation system precisely doses system cleansing solutions at programmed rates and frequencies.
   PFF Pod Chlorine Injection system precisely doses programmed rates of concentrated chlorine into pre-filtration source water reclamation holding tanks
   PFF Pod re-mineralized Reverse Osmosis (RO) water recirculating line has an integrated UV water treatment device and nano bubble generator. The nano bubble generator injects water that has high levels of dissolved oxygen into the recirculating reservoir each time the recirculating reservoirs' auto fill is triggered.
   Each of the NFT pod and Propagation pod recirculating reservoirs have an integrated sand filter and UV water treatment device integrated into the system to kill algae and fungal spores.
c. As noted earlier the instant invention has a nano bubble generator installed in the re-mineralized RO water recirculating line in addition to a UV water treatment device. The nano bubble generator connects directly to an oxygen tank (or oxygen generator). The control system utilizes a pressure switch, and a gravity drain valve to control the nano bubble generator. When the gravity drain valve is activated which means that the O₂ tank pressure switch indicates insufficient oxygen flow or the recirculating line water flow switch indicates insufficient water flow rate the control system turns off the nano bubble generator.
d. The instant invention uses a sand filter, capable of backwashing, and a machine washable and reusable eco-friendly filter media. The sand filter is installed on the outside of the NFT pod next to the water chiller.
e. A UV water treatment device, is install after the sand filter and prior to the water chiller. The device is either ON or OFF. The UV water treatment device is controlled by the control system, which turns the UV water treatment device on or off based on the state of the recirculating line water flow switch. When water flow is ON, the UV light is ON. When water flow if OFF, UV light is OFF.

Water Dosing Control (PFF pod).
a. The instant invention dosing injectors are preferably compressed air dosing injectors. However, any suitable pumping system can be used, such as a lab-grade peristaltic or diaphragm-based dosing pumps. The central fertigation system uses eight pumps to dose different nutrients. The preferred installation provides for three nutrients, but the instant invention can be configured to infuse from 1 to 10 different nutrients. The preferred embodiment has three nutrients: Nutrient A, Nutrient B, Nutrient C, as well as Supplement 1, Supplement 2, pH Up, Ph Down, and sanitizing solution infused into the water base on parameters programmed into the control system. The pumps are controlled by the program input into the control system, and injections are based on mL/gallon recipes defined in the control system. The control system uses sensor readings from the pH and EC sensors on the recirculating lines of each reservoir to determine the dosages of each nutrient, supplement sanitizer, and pH control solution. The flexibility designed into the system provides the ability to send specified nutrient recipes to the different recirculating nutrient reservoirs. This flexibility provides the user extensive formulation opportunities which can provide the proper nutrient, supplement sanitizer and pH control solution for each variety of plants under cultivation within the instant invention thereby facilitating a high amount of nutrient recipe flexibility.

NFT Channels Water Flow (NFT Pod).
a. As noted, the instant invention has NFT zones installed in the NFT pods and attached to the NFT pod racks. The racks are installed with a downhill slope. Water is pumped to all NFT growing channels, and the water travels by gravity down the channels, through the drains and into the gutter, where it connects to the water return line under the racking system on both sides and then goes back into the recirculating reservoir.

Propagation Nursery Flood & Drain Tables Water Control (PFF Pod).
a. The PFF pod contains flood and drain racks with at least six growing levels per rack. Each of the racks has its own dedicated fill and drain valves connected to the flood & drain tables. The flood & drain tables are filled and drained one at a time to minimize the amount of water required in the PFF Room's recirculating reservoir. The system has one high side valve and one low side valve, which are connected to the recirculating reservoir and are installed on opposite ends of each flood table drain trough. The low side valve is the supply/feed connection and the high side valve is an overflow drain that drains back to the recirculating reservoir. Using schedules programed into the control system the control system controls the frequency and duration of water flow. The control system activates both valves simultaneously on one rack, opening water flow to flood the tables and closing the drain valve on the supply/feed line. When the configured feed duration has been reached, the drain valve opens and supply/feed valve closes. This allows all six flood tables to drain completely through the supply/feed line and directed back to the water return line. The control system is preferably configured to feed each rack in 30 minutes intervals, one at a time. The time duration of the feedings can be scheduled by the grower using the control system. The average grower will schedule typically 1-2 feedings per day. Each flood table is installed is configured with quick connect unions on both the overflow drain line and the supply/feed line so they can be removed for cleaning and maintenance purposes.

Water Supply/Feed (NFT Pod).
a. Water supply/feed manifolds for NFT channel zones are removeable. The manifolds are removal to support ease of maintenance, which is required to eliminate any clogging due to debris, biofilm, or calcium scale.

Water Returns (NFT Pod).
i. The water return system uses 3 main components:
   a. row gutters;
   b. zone downspout; and
   c. Y junctions for the gutters to plug into.
Each downspout ties into main water return line and that return line runs the length of NFT channel zones back to the recirculating water reservoir.

Pumps (NFT Pods and PFF Pod).
I. The NFT Pod recirculating water supply system utilizes a pump with a variable frequency drive (VFD) controller which is controlled by the control system.
II. The Propagation Nursery, Central Fertigation & RO System use a pump to draw water from the finished source water holding tank thru the central fertigation skid and out to each of the 9 recirculating reservoirs. The system does this as needed, based on water level, pH, and EC sensor readings and the program in the control system. A second identical pump is used to draw water from pre-RO filtered source water holding tanks. Both pumps are activated when the control system senses a drop in pressure that occurs when either the finished source water holding tank needs water or one of the nine control valves on the central fertigation output manifold opens to injected water into a recirculating reservoir.

Filtration (PFF Pod only)—The reclaimed condensate and depleted nutrient water are pumped through a two-filter filtration station. A primary filter pre-filters elements from the water, and a secondary filter removes the finer elements in the water. After the water is filtered it passes thru a water flow switch that controls the concentrated chlorine solution inline injection process before the water is transferred to one of the source-water holding tanks. That water is then mixed with rainwater collected in second holding tank. The two tanks are plumbed together, and the RO system demand pressure pump is capable of simultaneously drawing water from both holding tanks. The third source water holding tank is filled thru a high side overflow from one of the other holding tanks and that holding tank is used for non-potable uses. The instant invention utilizes the following tanks to hold the various water types used or collected by the system.
i. Reclamation Water Holding Tanks.
   a. The Depleted Nutrient Water Reclamation & Settling Tank is filled from nine different recirculating reservoirs when a gravity flush control valve is opened via the control system with a high side overflow into the condensate reclamation tank.
   b. The Condensate Reclamation Tank with Sump Pump is filled from nine different HVAC climate systems and one Cold Storage refrigeration system with an integrated sump pump and high float switch to trigger the sump pump on and off. A current transformer (CT) Switch installed in the wiring circuit of the sump pump. This switch allows the control system to track when that pump is activated and deactivated.
   c. A holding tank for filtered condensate/depleted nutrient water.
   d. A holding tank for rainwater collection.
   e. A holding tank for overflow and outside landscape irrigation.
ii. A sediment filtration system is installed before the holding tanks and it is comprised of a primarily filter to pre-filter elements from the reclaimed, depleted nutrient water and a secondary filter to remove the finer elements from the reclaimed, depleted nutrient water before it is stored with the rainwater in the holding tank.
iii. A chlorine dosing system has a water flow switch, installed between the holding tanks and filtration system. The filtration system is comprised of a primarily filter to pre-filter elements from the water and a secondary filter to remove the finer elements from the water. The water flow switch initiates the peristaltic pump to inject a liquid chlorine/sanitizing solution at the desired rate using the on-board feed rate control on the dosing pump which is controlled by the control system.

Reverse Osmosis System with Calcite Remineralization. The instant invention utilizes a four-stage reverse osmosis system with calcite remineralization.
i. Stage 1 removes chlorine and chloramine in the water.
ii. Stage 2 is an ion exchange water softener and brine tank to exchange calcium and magnesium ions which makes the water hard with sodium chloride ions.
iii. Stage 3 removes all sodium chloride and heavy metals ions.
iv. Stage 4 is the calcite re-mineralizing cartridge to add pH buffering alkalinity back into the finished source water before storing it in the finished source water holding tank.

Human Life Safety (NFT pods and PFF pod)
i. Human Safety features installed and programed into control system include:
   a. High CO₂ audible alarm based on user configurable control system program.
   b. High CO₂ automated ventilation based on user configurable control system program.
   c. Code compliant Fire/Smoke+Carbon monoxide audible alarm based on user configurable control system program.
   d. Accessible fire extinguisher mounted on wall in the event of a fire.
   e. Emergency battery powered lighted Exit sign in the event of a power outage.

The following is a listing of equipment integrated into the instant invention:

Climate Control Systems (*Control System Integrated)

| | |
|---|---|
| 1. | *HVAC (AC, Dehumidification, Ventilation) |
| 2. | *CO₂ Solenoid connected to Central CO₂ Tanks System with |
| | holed ¼″ tubing across the length of the inside ceiling |
| 3. | *NFT Lighting with 10″ canopy and DIM to OFF functions (108 × 4′ |
| | long sections OR 18 × 4′ long columns, 6 levels/ea.) |
| 4. | *Climate Sensor (Air Temp, Relative Humidity, and CO₂) mounted |
| | hanging from ceiling near front of the room/entry door |
| 5. | Redundant Backup Thermostat |
| 6. | Optional Secondary/Front Dehumidifier |
| 7. | NFT Canopy Quadruple Row Fans (36) |
| 8. | NFT Ceiling Circulation Fans (2) moving air from back to the front |
| | of the room |
| 9. | NFT Floor Circulation Fans (2) moving air from front to back of the |
| | room |
| 10. | Entry door 30″ air curtain triggered when door opens |

Water Dosing, Cleansing & Irrigation Control Systems
(*Control System Integrated)

| | |
|---|---|
| 11. | 20″ NFT Channels (72 - 2 Zones @ 36 per Zone, 6 levels) with Lids, |
| | Supply/Feed End Caps, and Drain Caps |
| 12. | 16′ NFT Channels (72 - 2 Zones @ 36 per Zone, 6 levels) with Lids, |
| | Supply/Feed End Caps, and Drain Caps |
| 13. | *NFT Reservoir Fill (from Central Fertigation) motorized ball valve |
| | (normally closed) |
| 14. | *NFT Reservoir Fill (from Carbon Filter only) motorized ball valve |
| | (normally closed) |
| 15. | *NFT Reservoir Gravity Flush motorized ball valve (normally closed) |
| 16. | *NFT Reservoir Pressurized Flush motorized ball valve (normally |
| | closed) |
| 17. | *NFT Water Flow Switch for Water Pump Main Irrigation Line |
| 18. | *NFT Water Flow Switch for Sensors-Sand Filter-UV Filter-Chiller |
| | Recirculating Line |
| 19. | *NFT Reservoir Temperature sensor |
| 20. | *NFT Reservoir pH sensor |
| 21. | *NFT Reservoir EC (nutrient level) sensor |
| 22. | *NFT Reservoir Water Level sensor |
| 23. | *NFT Control Panel Power Loss Switches (2) |
| 24. | NFT Recirculating line Sand Filter |
| 25. | NFT Recirculating line UV filter rated for up to 15 gallons per minute |
| 26. | Inside NFT Reservoir Fill Shut Off Ball Valve |
| 27. | Exterior Central CO2 Shut Off Valve |
| 28. | 2HP Aqua Culture Rated Continuous Duty Water Pump |
| 29. | *Variable Frequency Drive (VFD) Pump Controller |
| 30. | 1.5 HP Outdoor Water Chiller w/Inside Thermostat |
| 31. | NFT Main Pump Irrigation Feed line 2″ Spin Down filter with 60 |
| | mesh rated filter screen |
| 32. | NFT Zone Flow Rate Ball Valves (4) |
| 33. | NFT Row Level Flow Rate Ball Valves (24) |
| 34. | NFT Removable Supply/Feed Manifolds (24) |
| 35. | Custom Cantilevered Racking for 2 × 16′ Zones |
| 36. | Custom Cantilevered Racking for 2 × 20′ Zones |

Human Life Safety (*Control System Integrated)

| | |
|---|---|
| 37. | *Audible siren integrated to control system digital alerts (High CO₂) |
| 38. | *Audible Smoke/Fire + CO alarms integrated to control system |
| | digital alerts |
| 39. | *Audible Smoke/Fire + CO alarm relays to whole site Fire |
| | Emergency System |
| 40. | Lighted Exit Signs with Battery powered emergency lighting |
| 41. | Wall mounted fire extinguisher |

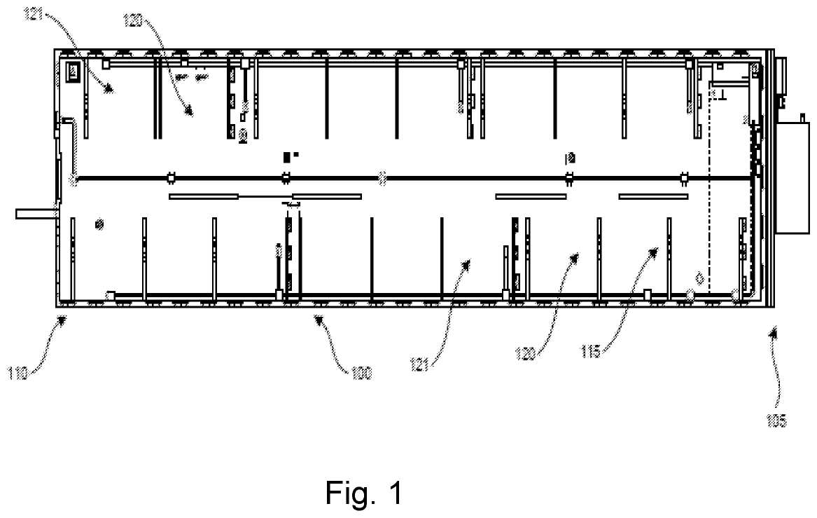

FIG. 1-20 and more particularly FIG. 1 shows a top cutaway view of standalone Pod 100 of the instant invention showing the racks that support the grow channels, water distribution and HVAV system. Distal end 110 and proximal end 105 are shown as well as a Nursery/Propagation Zone 115 and typical Growing Zone 121 with NFT channels 120 (only two identified for clarity).

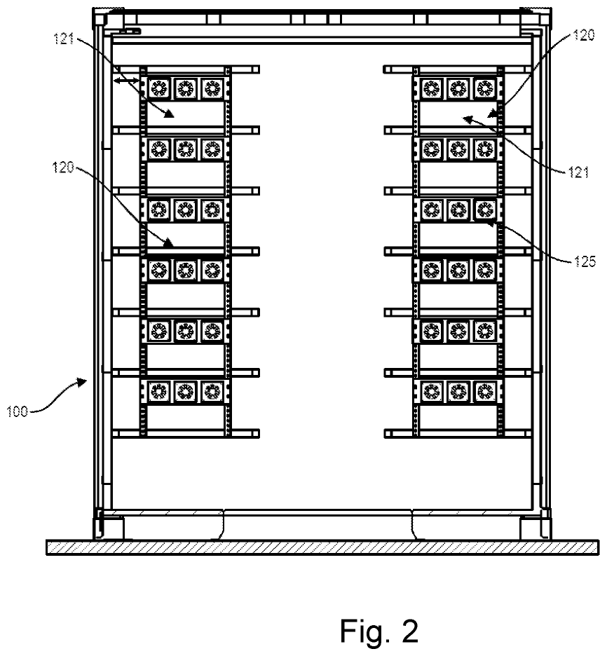

FIG. 2 shows a distal end view of the racks looking inward from the distal wall of the standalone pod 100. The row fans 125 are shown in each shelf of a typical column forming a typical Growing Zone 121 with NFT channels 120 (only two identified for clarity). The row fans 125 are mounted on each row to provide humidity reducing air flow across the top of the crop canopy.

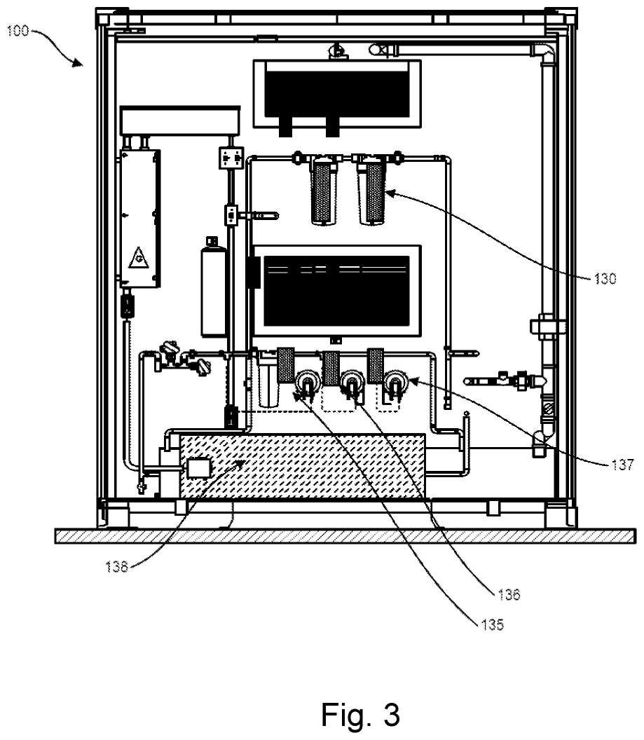

FIG. 3 is a proximal end view of the equipment mounted on the interior of the proximal wall of the standalone pod 100. The source water filter housings 130, reservoir 138, peristaltic dosing pumps 135, 136 and 137 are shown.

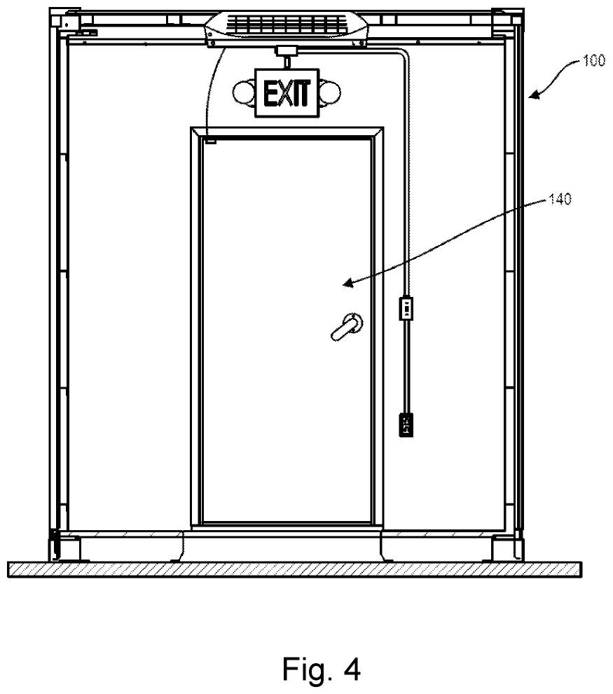

FIG. 4 is a proximal end view of the container looking at the exterior proximal wall of the standalone pod 100 from inside the standalone pod 100. The door 140 is shown.

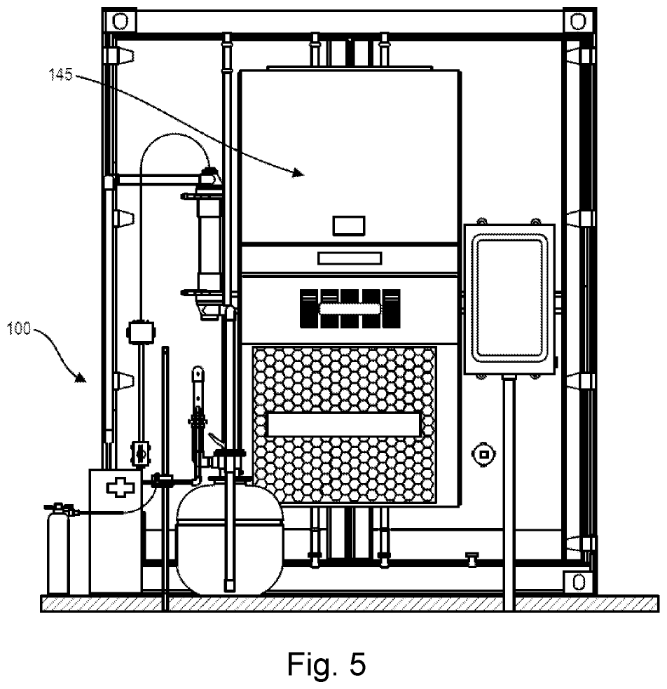

FIG. 5 is a distal end view of the exterior of the distal wall of the standalone pod 100 showing HVAC system 145.

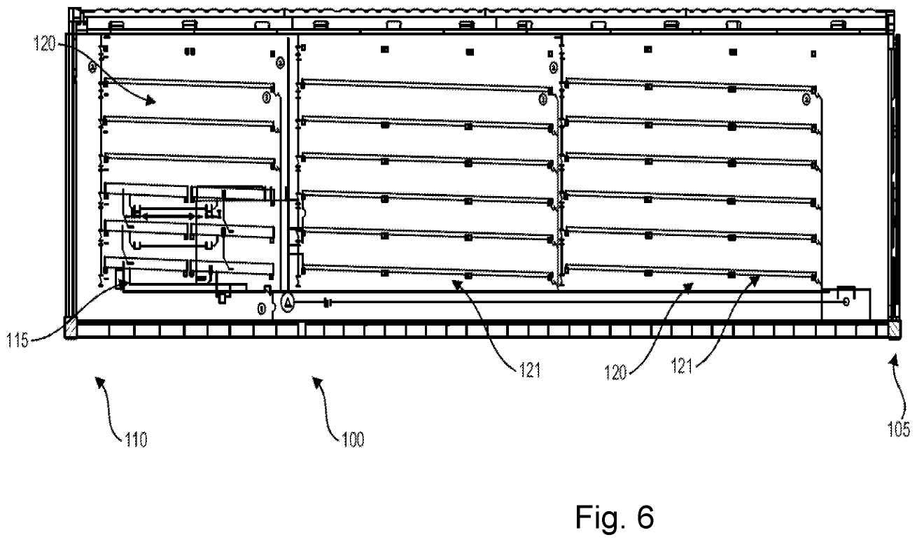

FIG. 6 is a cutaway elevation view of standalone pod 100 looking to the left side of the instant invention showing standalone pod 100 of the instant invention, distal end 110 and proximal end 105, grow zones 121 with NFT channels 120 (only two identified for clarity) and propagation (nursery) zone 115.

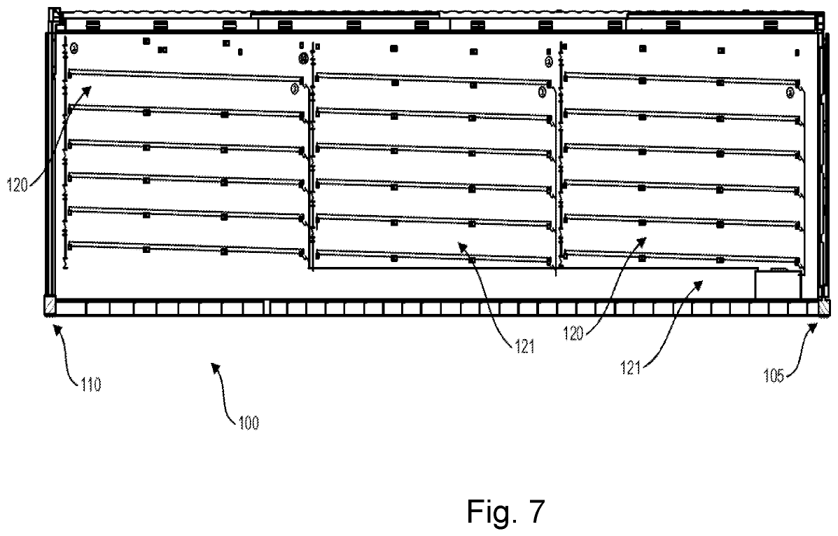

FIG. 7 is a cutaway elevation view of NFT pod 100 looking to the right side of the instant invention showing standalone pod 100 of the instant invention, distal end 110 and proximal end 105, grow zones 121 with NFT channels 120 (only two identified for clarity).

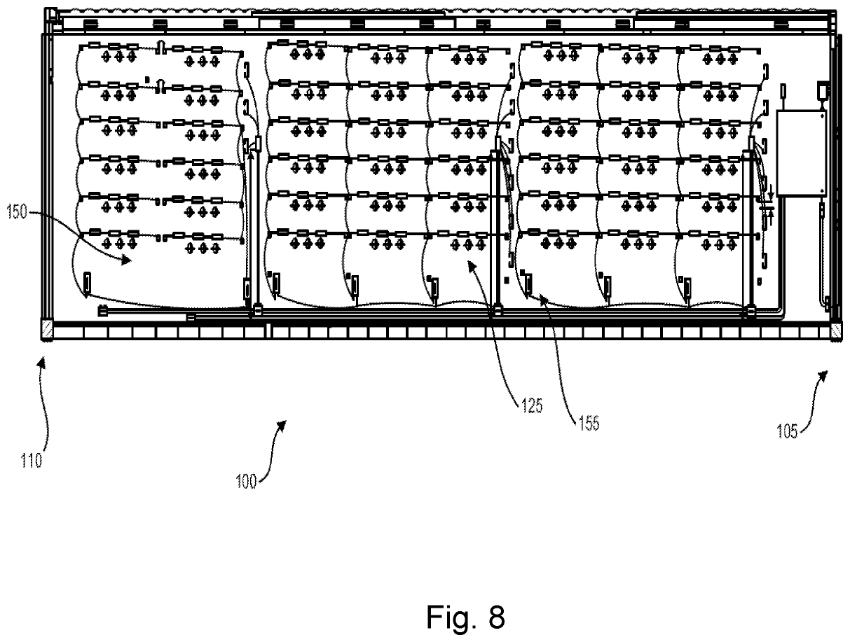

FIG. 8 is a cutaway elevation view looking to the left side of the instant invention showing standalone pod 100, distal end 110 and proximal end 105, typical lighting 150 (indicates 3 light bars) and lighting power supply/ballast 155, and typical row fans 125 (shown in FIG. 2). The lighting 150 comprises of 6×3 bar light fixtures daisy chain straight down to 1 power supply/ballast. Power supplies in each zone are daisy chain together for a single tie into that zone's lighting circuit junction box.

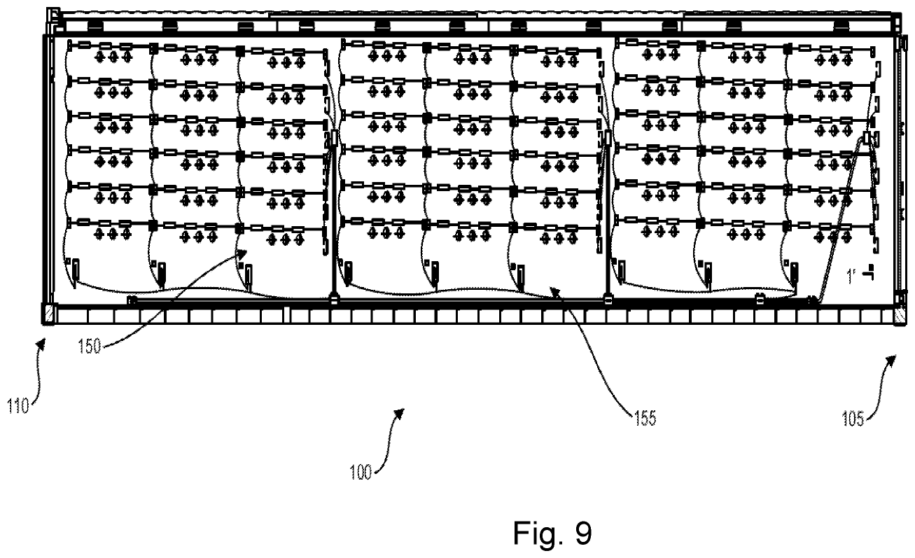

FIG. 9 is a cutaway elevation view looking to the left side of the instant invention showing standalone pod 100, distal end 110 and proximal end 105, typical lighting 150 (indicates 3 light bars) and lighting power supply/ballast 155, and typical row fans (shown in FIG. 2). The lighting 150 comprises of 6×3 bar light fixtures daisy chain straight down to 1 power supply/ballast. Power supplies in each zone are daisy chain together for a single tie into that zone's lighting circuit junction box.

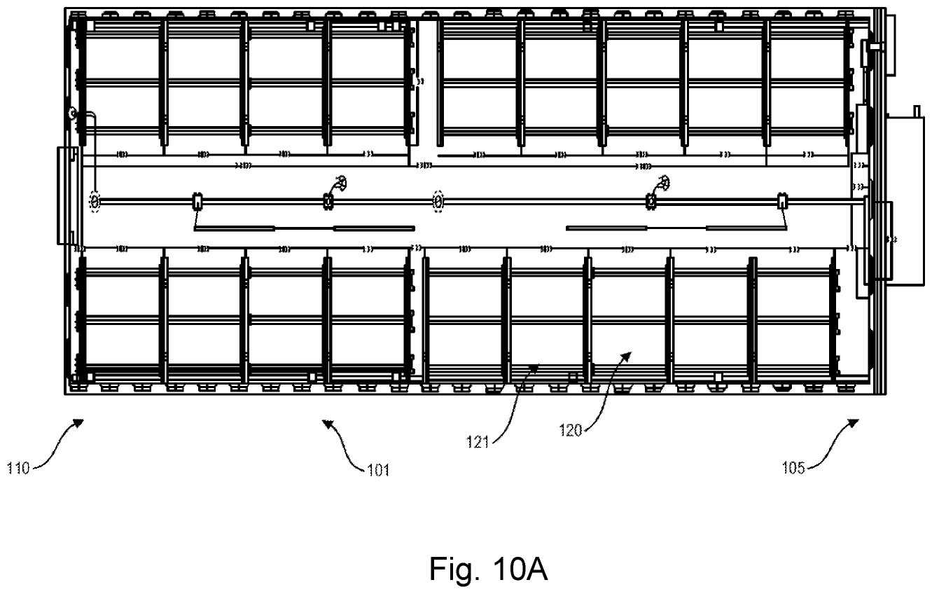

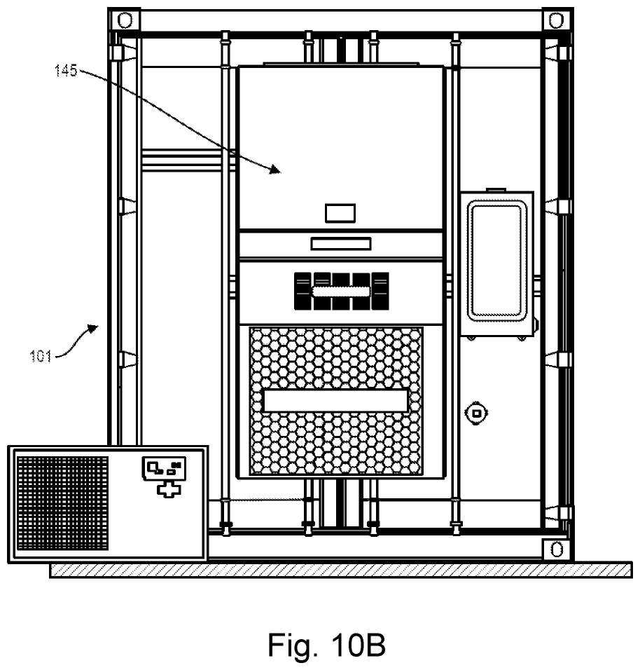

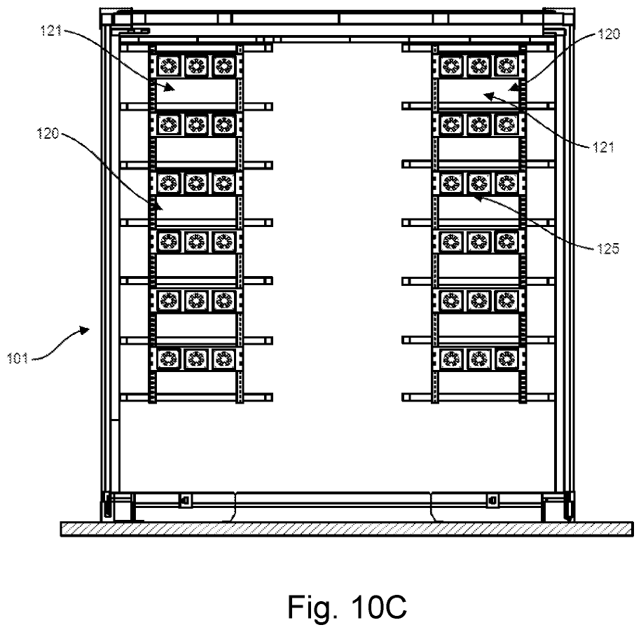

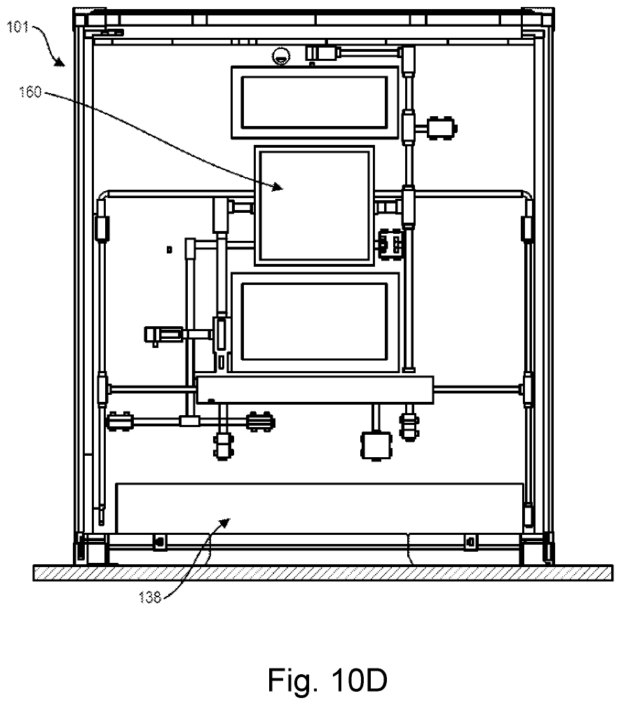

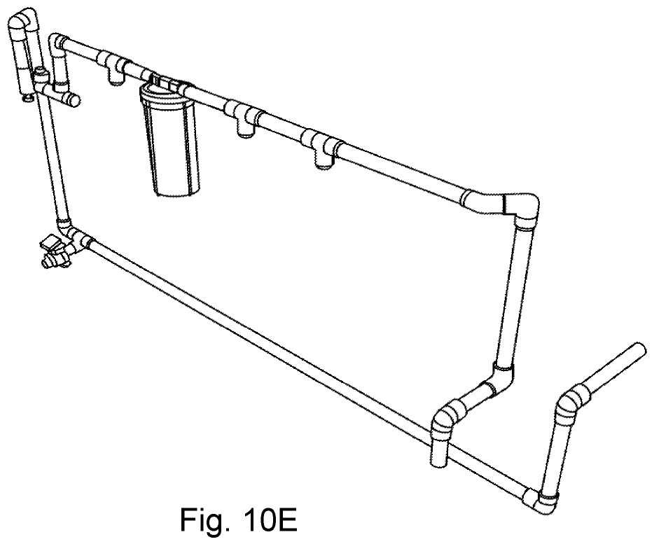

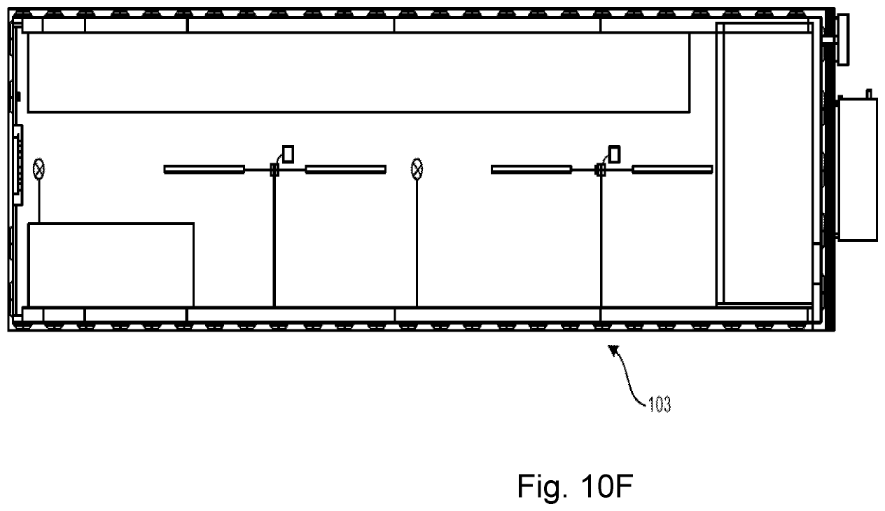

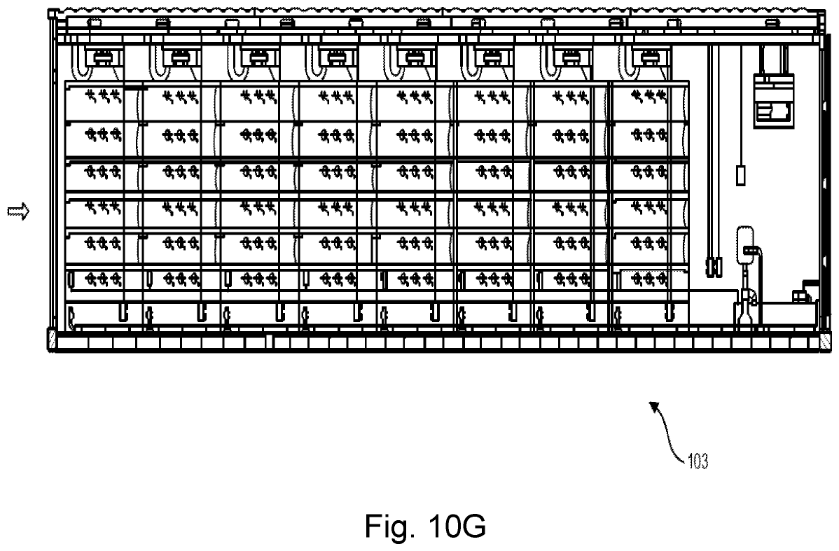

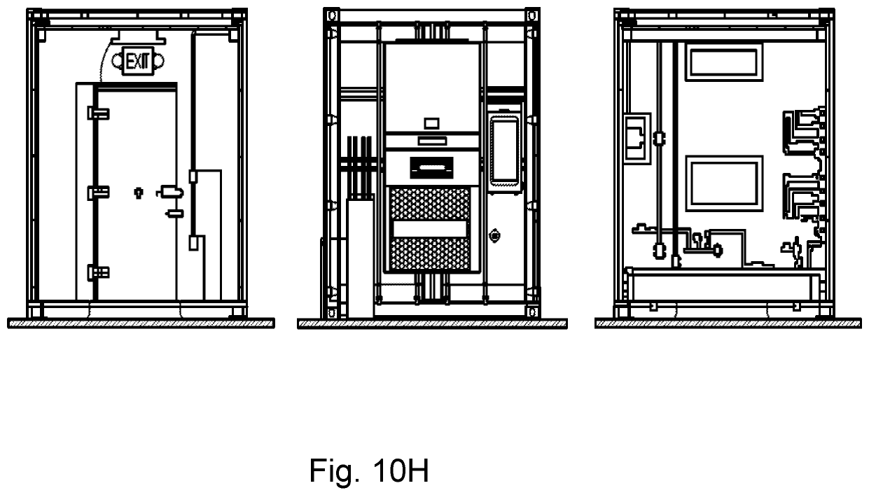

FIG. 10A-H shows a plan view layout of the NFT pod 101 layout of the instant invention showing the racks that support the grow channels, water distribution and HVAV system. Distal end 110 and proximal end 105 are shown as well as typical Growing Zone 121 with typical NFT channels 120. FIG. 10E shows the dosing loop plumbing schematic of the NFT container of the instant invention.

FIG. 10B shows the exterior wall view of the NFT pod 101 layout of the instant invention showing the HVAC system 145.

FIG. 10C is an interior view that shows the zone fans and grow racks of the NFT pod of the instant invention NFT pod 101. The row fans 125 are shown in each shelf of a typical column forming a typical Growing Zone 121 with NFT channels 120 (only two identified for clarity). The row fans 125 are mounted on each row to provide humidity reducing air flow across the top of the crop canopy.

FIG. 10D shows the control panel 160 and water tank 138 of the NFT pod 101 of the instant invention

FIG. 10E shows the dosing loop plumbing schematic of the NFT container of the instant invention.

FIG. 10F shows a plan view layout of the PFF pod 103 layout of the instant invention.

FIG. 10G shows an elevation side view layout of the PFF pod 103 layout of the instant invention showing the zone and bay lighting layout.

FIG. 10H shows representative elevation end view layouts of the PFF pod 103 layout of the instant invention.

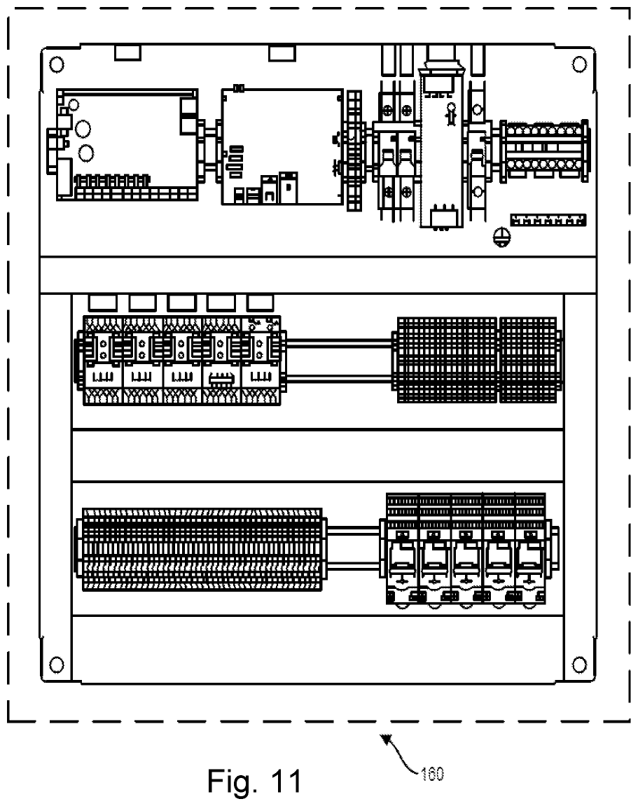

FIG. 11 shows the system controller 160 of the instant invention.

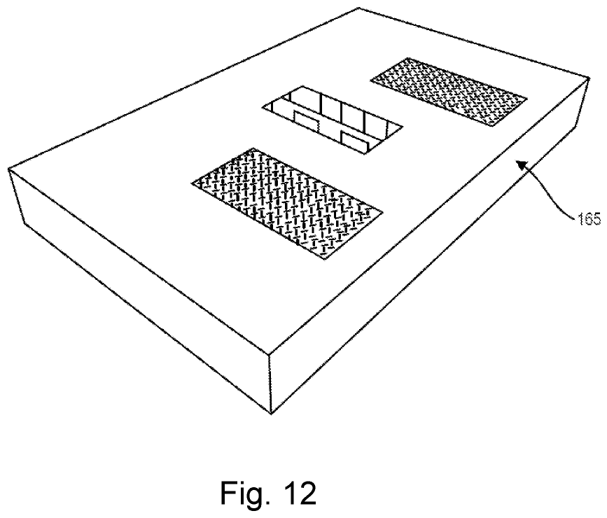

FIG. 12 shows an isometric view of the water tank 165 used in the NFT containers;

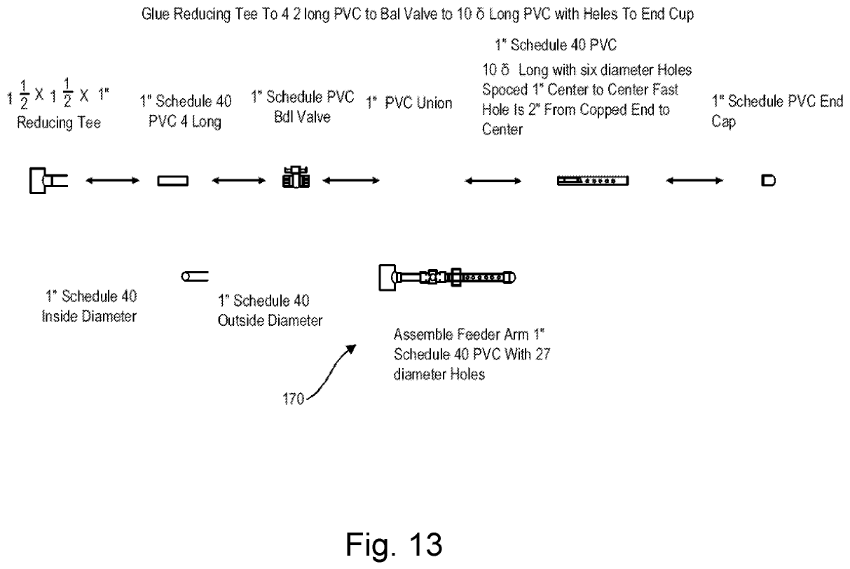

FIG. 13 shows a typical feeder arm assembly 170 used in the NFT container;

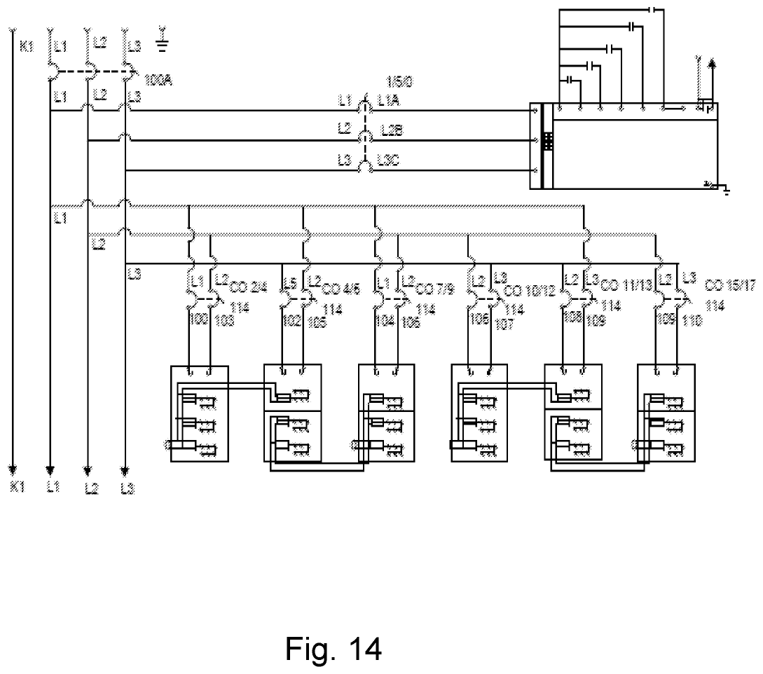

FIG. 14 shows a typical HVAC and lighting schematic of the instant invention.

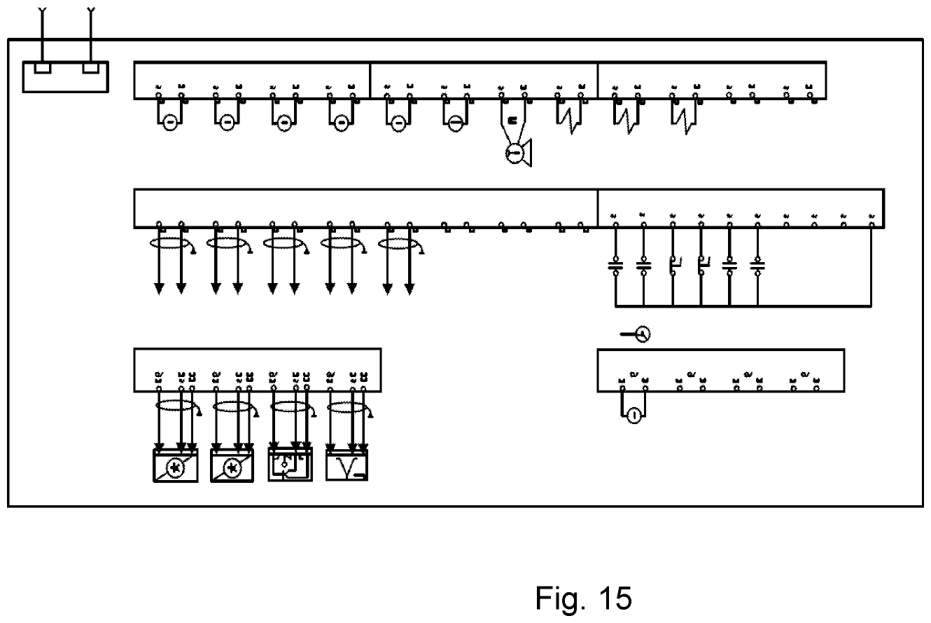

FIG. 15 shows a typical Input and Output (I/O) schematic of the instant invention.

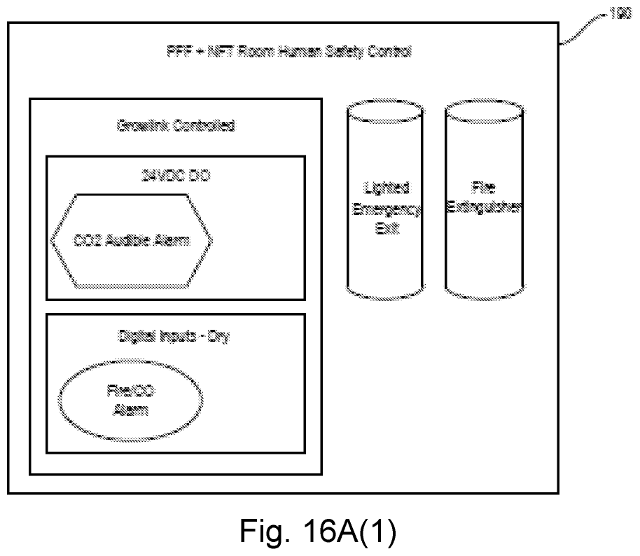

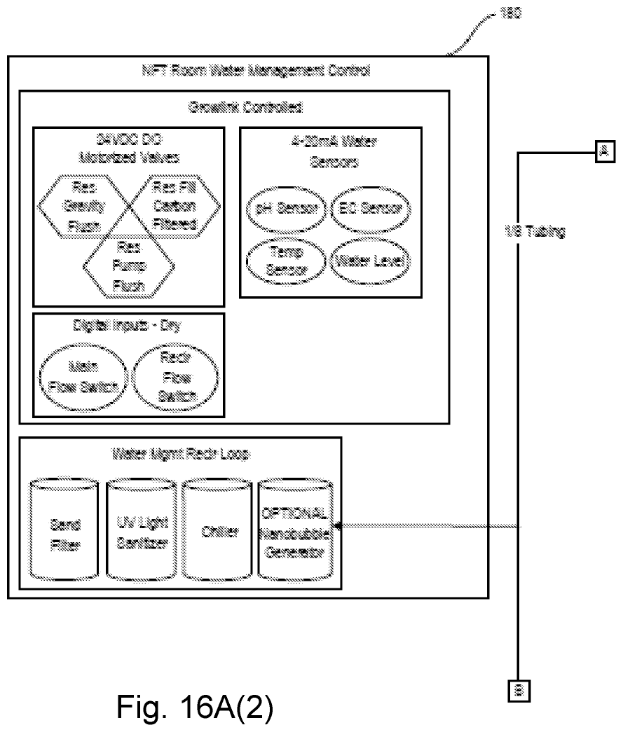

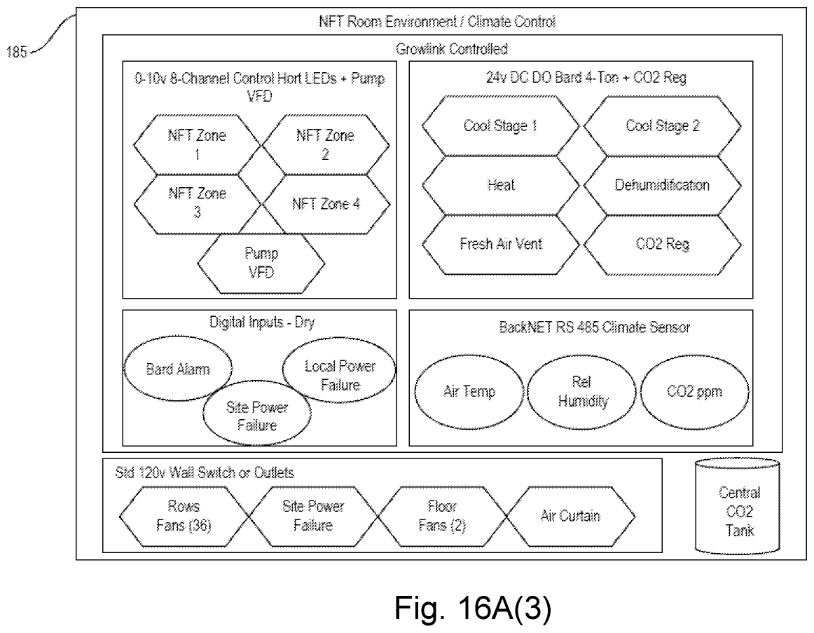

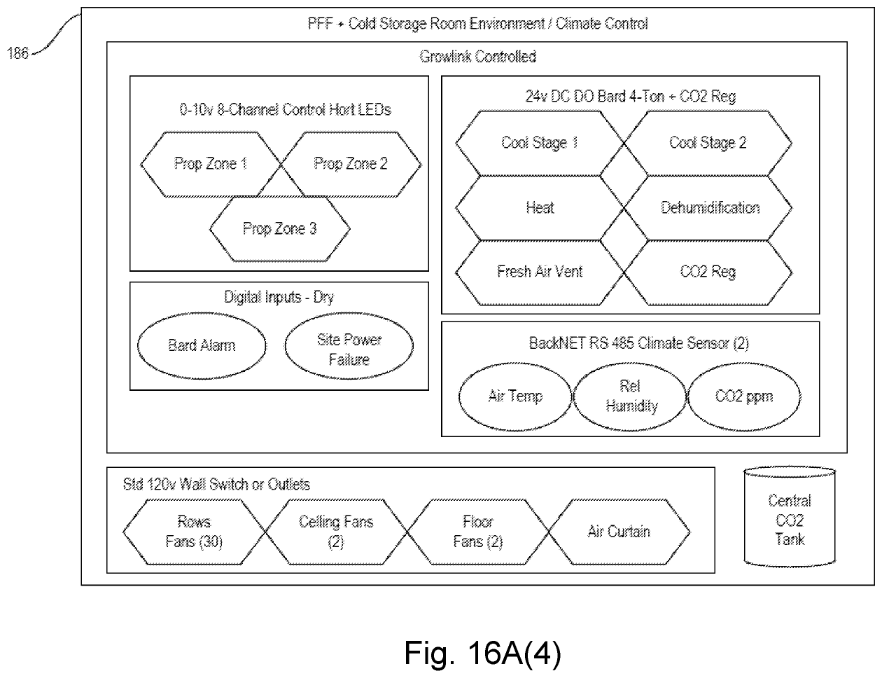

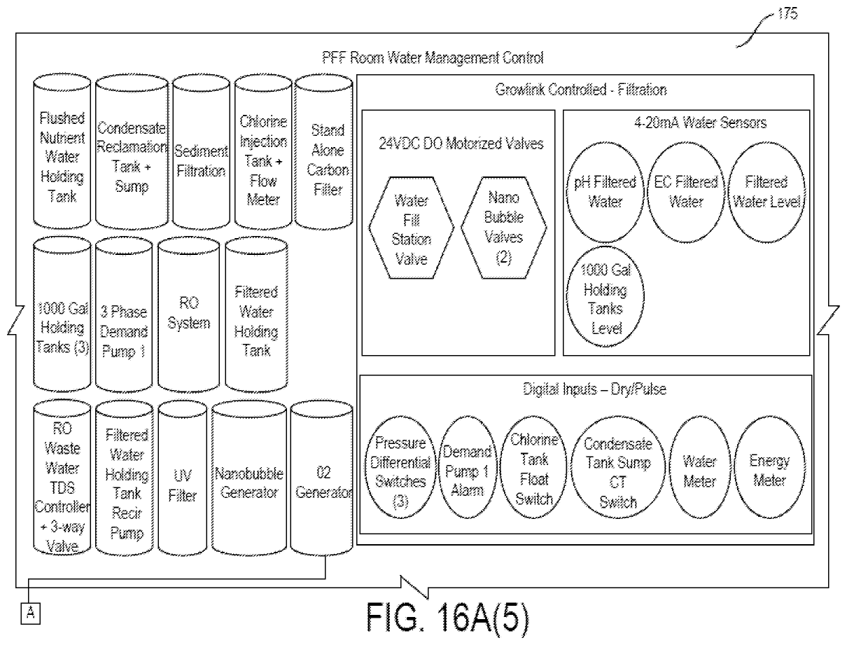

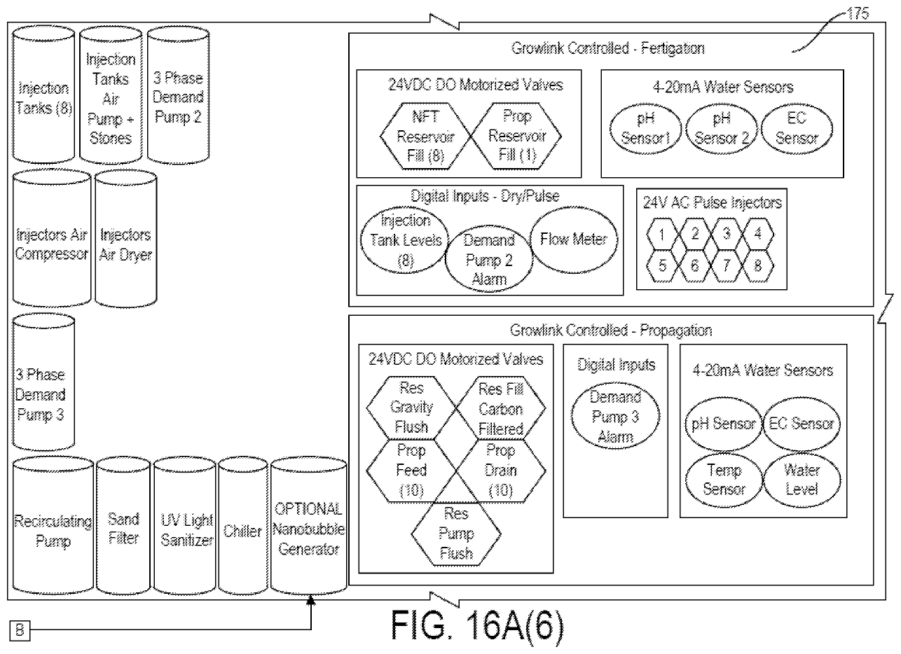

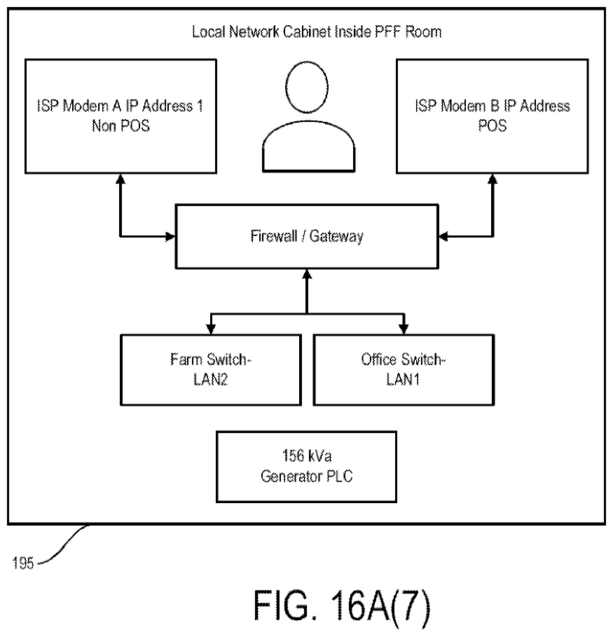

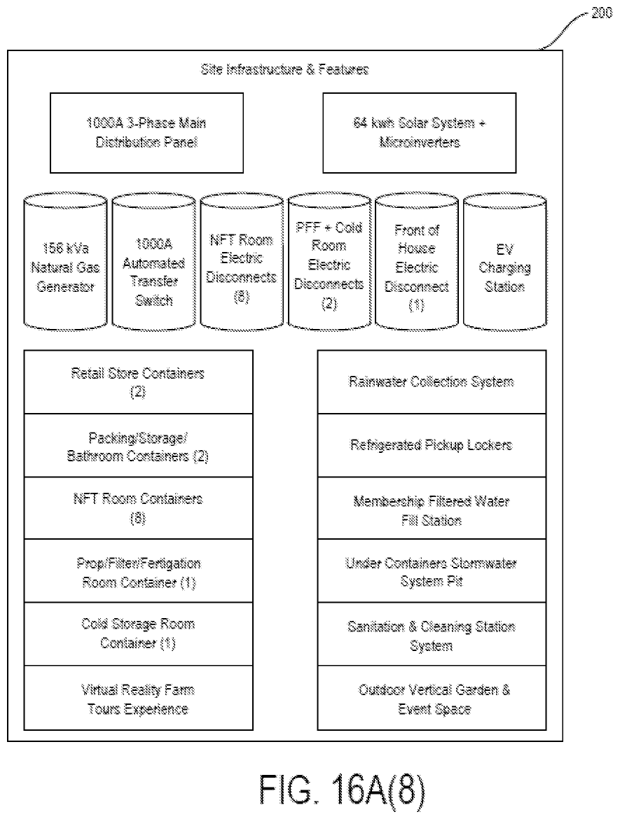

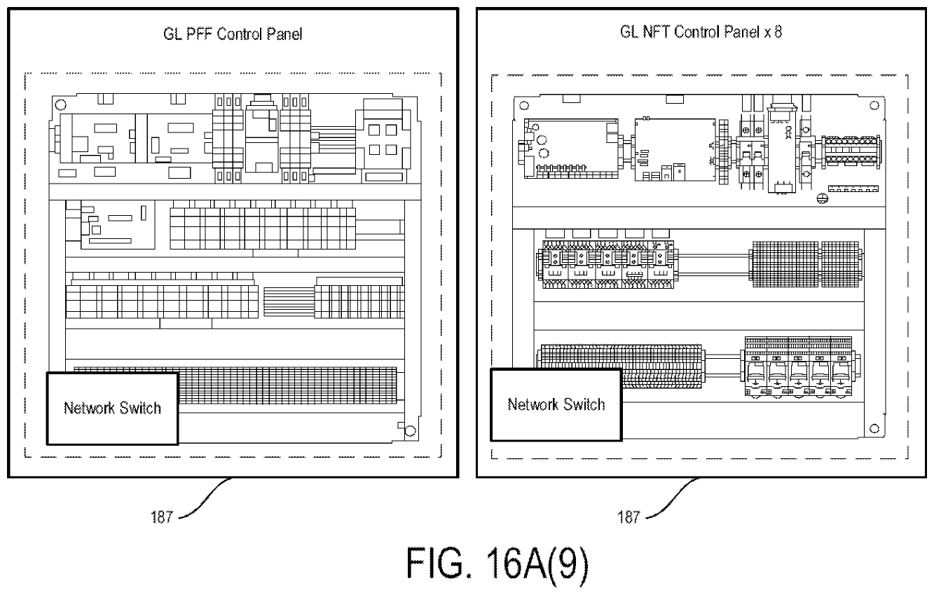

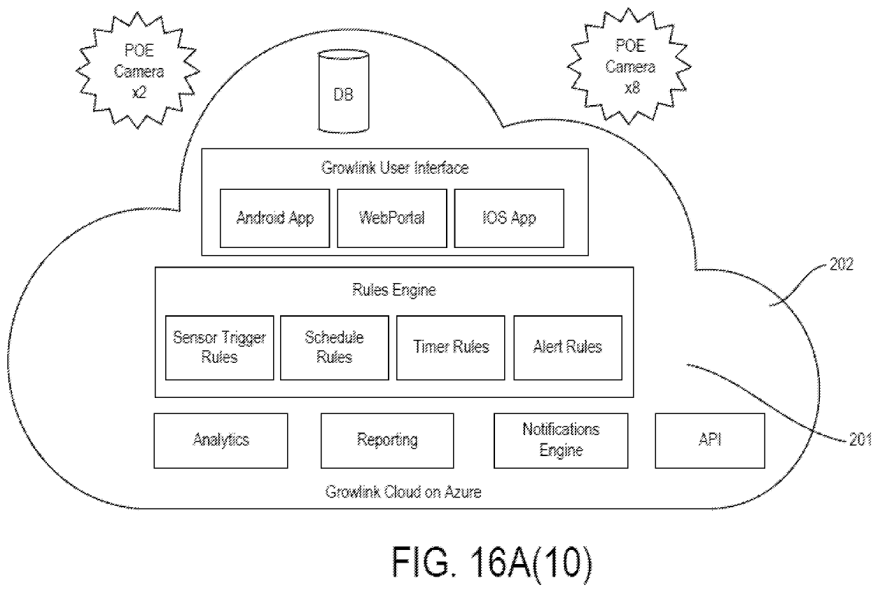

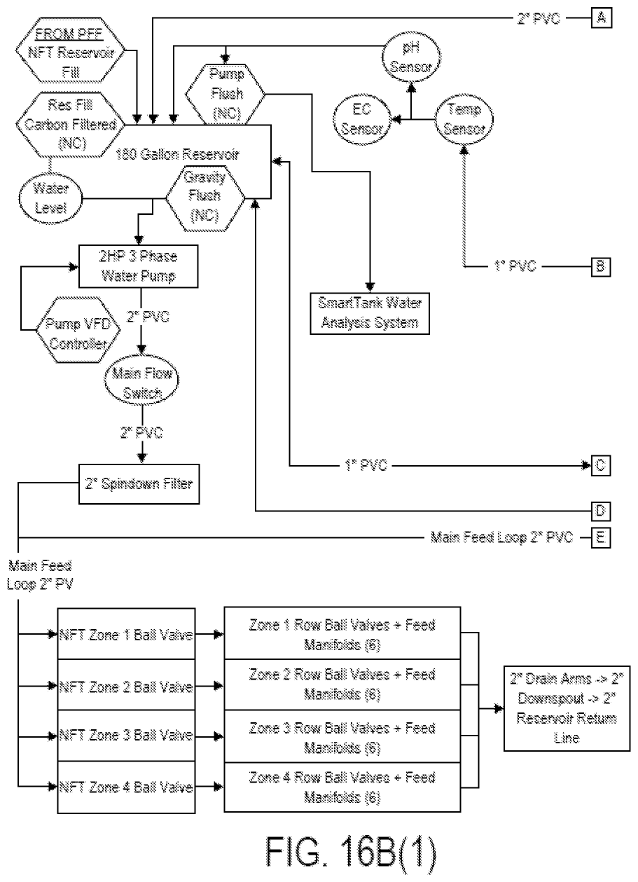

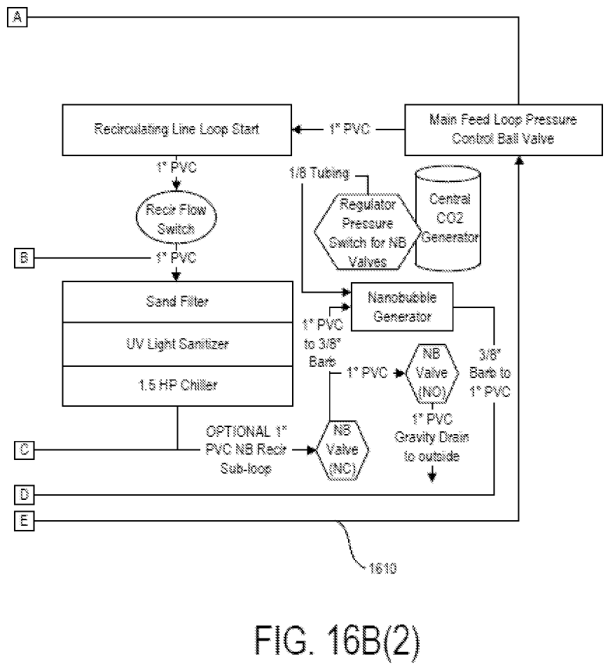

FIG. 16A(1)-16A(10) shows a block diagram of the system controller system including PFF Room Water Management Control 175 and the NFT Room Water Management Control 180, NFT Room Environment/Climate Control 185, PFF and NFT Room Human Safety Control 190, local network 195, PFF+Cold Storage Room Environment/Climate Control 186, PFF Control Panel 187, NFT Control Panels 187, Climate Sensor Site Infrastructure and Features 200, cloud management system 202 and data warehouse and control application 201. The control application 201 allows the users to monitor the processes used in the PFF pods 103 and NFT pods 101 as well as make adjustments to parameters. The invention utilizes processors and monitoring devices which are connected by Internet of Things (IoT) technology to remotely control and monitor the system components which facilitates the user to analyze sensor data for business intelligence purposes as well as growing data to maximize the plant health and the productivity of the farm.

FIG. 16B(1)-16B(2) shows block diagrams of the NFT water management system 1610.

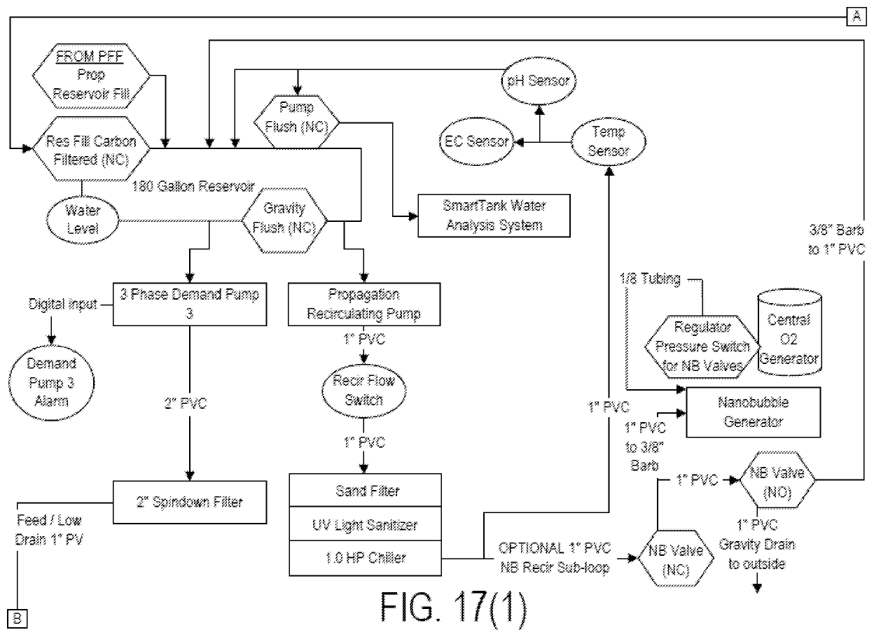

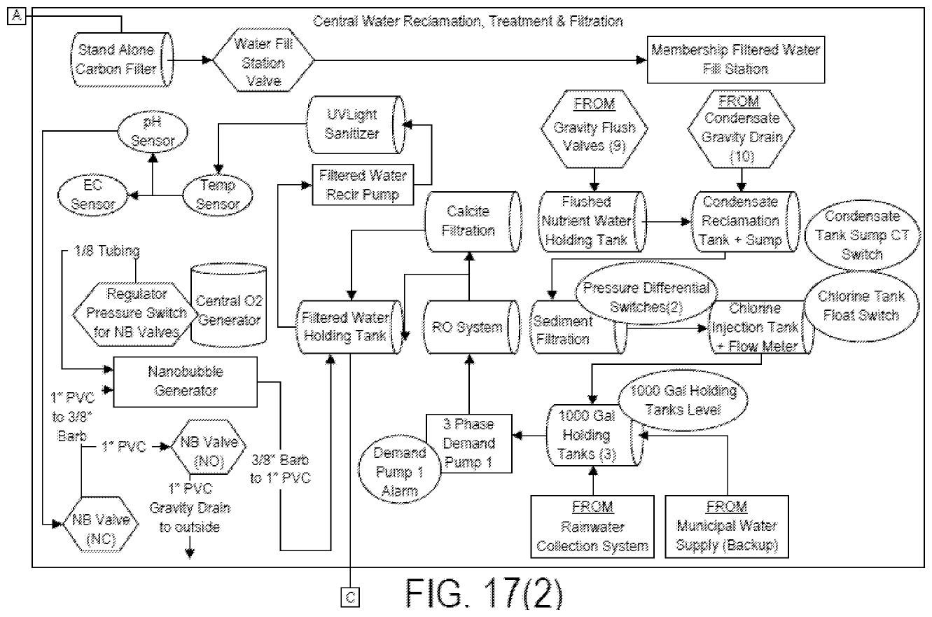

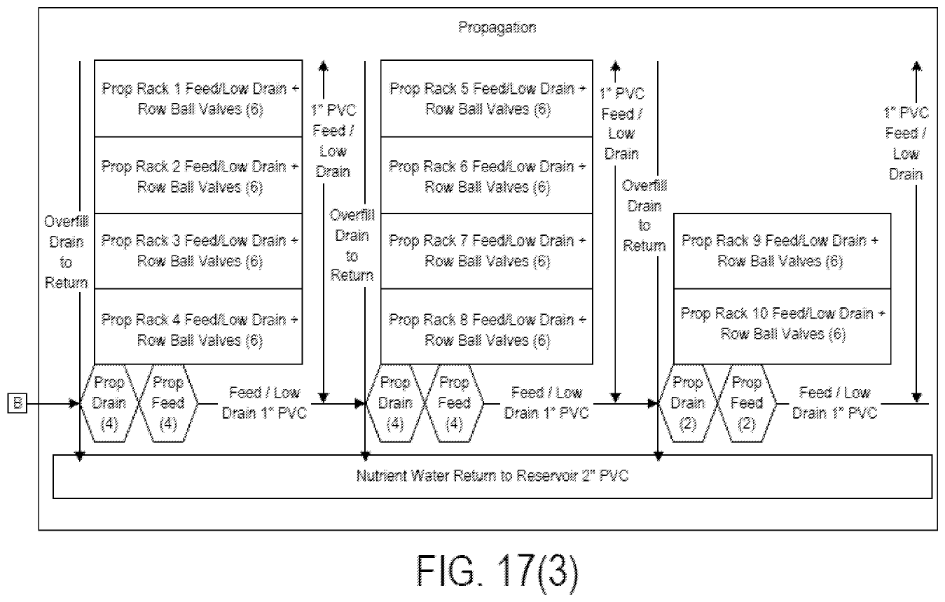

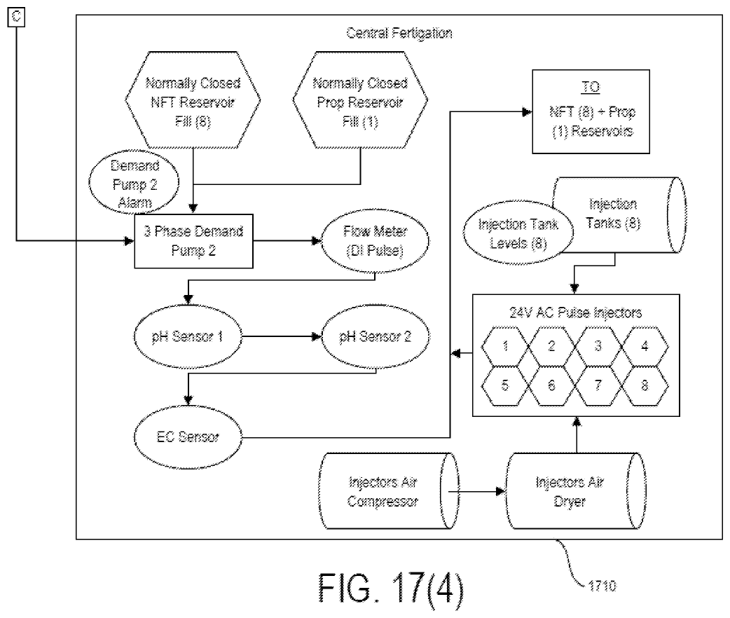

FIG. 17(1)-17(4) shows block diagrams of the PFF water management control system 1710.

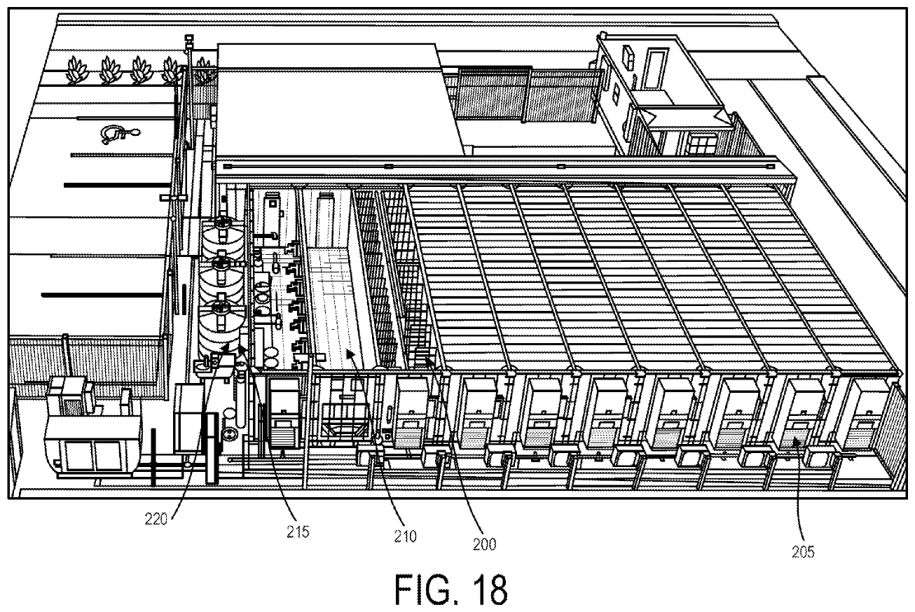

FIG. 18 shows a perspective view of a configuration of eight grow pods 200 (one identified for clarity) and a single pod nursey 210 system. The HVAC unit 205 (one identified for clarity) is shown for a typical pod as well as a source water holding tank 220 (one identified for clarity) in external area 215.

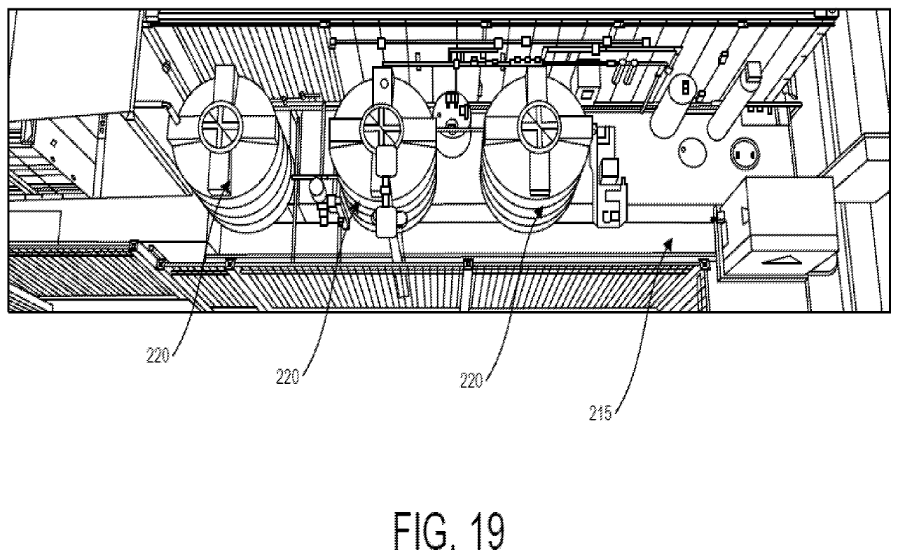

FIG. 19 shows the source water holding tanks 220 supply for nutrients for the system in external area 215.

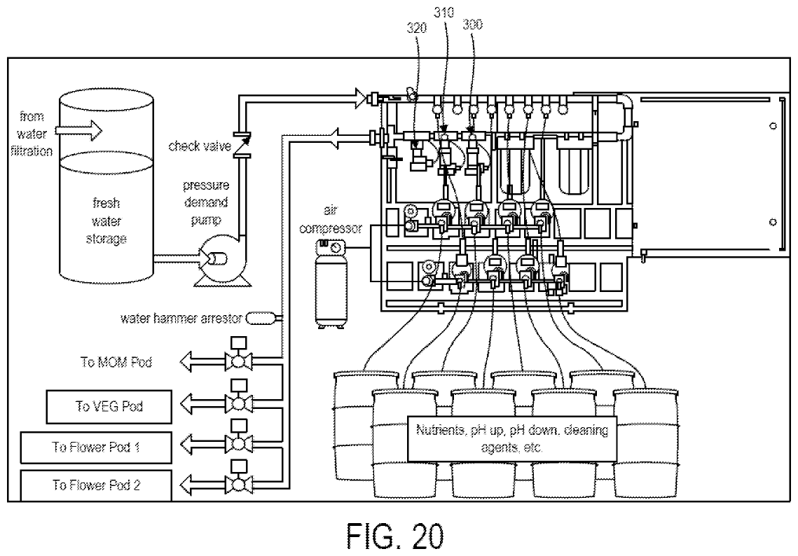

FIG. 20 shows the central fertigation overview showing the mixing and fresh water storage schematic. The blue mixing chambers are used to prevent precipitation, which can lead to reforming of solids and making nutrients unavailable for plant root uptake. Inside the mixing chamber is a pipe with 5×¼″ diameter holes on opposite sides of the pipe. The schematic shows 2 pH sensors 300 and 310 (yellow)+1 EC sensor 320 (yellow), 1 Flow Rate Meter, and 3 pressure gauges are used to ensure the system is operating at optimal flow rate and pressure. Due to pH sensors delicate nature, a backup pH sensor the instant invention utilizes a second pH sensor for redundancy purposes.

In some embodiments, the system, method or methods described above may be executed or carried out by a computing system including a tangible computer-readable storage medium, also described herein as a storage machine, that holds machine-readable instructions executable by a logic machine such as a processor or programmable control device to provide, implement, perform, and/or enact the above described methods, processes and/or tasks. When such methods and processes are implemented, the state of the storage machine may be changed to hold different data. For example, the storage machine may include memory devices such as various hard disk drives, CD, flash drives, cloud storage, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, game controllers, video camera, camera, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. (canceled)

2. A multi pod farm comprising:
a. an at least one NFT pod;
b. an at least one PFF pod;
c. an at least one market pod;
d. a nano bubble generator system;
e. a reverse osmosis system
f. a water management system having a recirculating reservoir;
g. an environment/climate control system;
h. a human safety control system;
i. a local network; and
j. a cloud management system.

3. The multi pod farm of claim 2 wherein said water management system having said recirculating reservoir has a recirculating pump.

4. The multi pod farm of claim 2 wherein said nano bubble generator system injects water with high levels of dissolved oxygen into said recirculating reservoir each time said recirculating reservoir is filled.

5. The multi pod farm of claim 2 wherein said PFF pod comprises a water dosing control system and said water dosing control system comprises of compress air dosing injectors.

6. The multi pod farm of claim 2 wherein said NFT pod comprises of at least one NFT zone having at least one rack and said rack having grow channels.

7. The multi pod farm of claim 2 wherein said PFF pod comprises at least one drain rack.

8. The multi pod farm of claim 2 wherein said PFF pod comprises at least one flood rack.

9. The multi pod farm of claim 2 wherein said at least one drain rack has a dedicated fill valve.

10. The multi pod farm of claim 2 wherein said at least one flood rack has a dedicated fill valve.

11. The multi pod farm of claim 2 wherein said reverse osmosis system has four stages and said stages comprising a chlorine and chloramine removal stage, an ion exchange stage, a sodium chloride and heavy metal ion removal stage and a calcite remineralization.

12. The multi pod farm of claim 2 wherein said PFF pod comprises a PFF filtration system and said PFF filtration system has a PFF filtration system primary filter and a PFF filtration system secondary filter.

13. The multi pod farm of claim 2 wherein said water management system has a depleted nutrient water reclamation and settling tank, a condensate reclamation tank, a holding tank for filtered condensate/depleted nutrient water, a holding tank for rainwater collection and a holding tank for overflow and outside landscape irrigation.

14. The multi pod farm of claim 2 wherein said at least one market pod has retail space.

15. A multi pod farm comprising:
a. at least one NFT pod;
b. at least one PFF pod;
c. at least one market pod;
d. nano bubble generator system;
e. reverse osmosis system
f. a water management system;
g. an environment/climate control system;
h. a human safety control system;
i. water reclamation system;
j. microgrid energy grid;
k. rainwater collection system;
l. condensate reclamation system;
m. depleted nutrient water reclamation system;
n. a local network; and
o. a cloud management system

16. The multi pod farm of claim 15 wherein said at least one market pod has refrigerated pickup lockers.

17. The multi pod farm of claim 15 wherein said nano bubble generator system injects water with high levels of dissolved oxygen into the recirculating reservoir each time said recirculating reservoir is filled.

18. The multi pod farm of claim 15 wherein said nano bubble generator system is connected to an oxygen supply.

19. The multi pod farm of claim 18 wherein said oxygen supply is selected from the group consisting of an oxygen tank and an oxygen generator.
